(19) United States
(12) Patent Application Publication
(10) Pub. No.: US 2024/0420026 A1
(43) Pub. Date: Dec. 19, 2024

(54) SYSTEMS AND METHODS FOR ADVANCED PREDICTION USING MACHINE-LEARNING AND STATISTICAL MODELS

(71) Applicant: Mars, Incorporated, McLean, VA (US)

(72) Inventors: Jeff BREEDING-ALLISON, North Middletown, NJ (US); Kylie TAYLOR, Nashville, TN (US); Paul LEDWITH, Lower Stondon (GB)

(21) Appl. No.: 18/742,501

(22) Filed: Jun. 13, 2024

Related U.S. Application Data
(60) Provisional application No. 63/508,247, filed on Jun. 14, 2023.

(51) Int. Cl. G06N 20/00

(52) U.S. Cl. CPC G06N 20/00

(57) ABSTRACT

Systems and methods are disclosed for implementing advanced statistical models and machine-learning algorithms to generate predictions. The method includes receiving a plurality of data from one or more sources; processing the plurality of data to select one or more relevant variables; training one or more prediction models based on the one or more relevant variables, and a combination of an advanced statistical model and a machine-learning model; evaluating performance of the one or more trained prediction models based on one or more validation techniques; and deploying at least one prediction model based on the performance for generating predictions.

### CROSS-REFERENCE TO RELATED APPLICATION(S)

This application claims the benefit of priority to U.S. Provisional Application No. 63/508,247, filed on Jun. 14, 2023, the entirety of which is incorporated herein by reference.

### TECHNICAL FIELD

This present disclosure relates generally to the field of machine learning, and more specifically, to predictive analysis and forecasting using advanced algorithms and models.

### BACKGROUND

Conventional forecasting models often rely on historical data and assume a relatively stable market environment, which makes them ill-equipped to handle sudden and unpredictable changes in consumer behavior. These forecasting models lack the flexibility to integrate data (e.g., emerging consumer preferences, market sentiments) which are crucial for adapting to rapid changes, thereby hindering their ability to react to changing market conditions. Conventional forecasting models rely on heavy assumptions about the data, which are rarely exactly true with real-world data. The conventional models' static nature also means that they do not dynamically adjust to rapid market changes or disruptions, resulting in forecasting errors and inventory imbalances. Conventional forecasting methods often struggle to accurately identify and account for outliers in the data, leading to skewed forecasts and inefficient inventory management. Such traditional forecasting approaches may face scalability challenges when dealing with large datasets or complex product assortments, resulting in longer processing times and decreased forecasting accuracy. There is a need for advanced forecasting methodologies that dynamically adapt to evolving market conditions, incorporate data sources, and effectively capture the complexities of modern consumer behavior.

### SUMMARY OF THE DISCLOSURE

According to aspects of the present disclosure, systems and computer-implemented methods are disclosed for adaptive forecasting using advanced statistical models and machine-learning algorithms.

In some embodiments, a computer-implemented method includes: receiving, by one or more processors, a plurality of data from one or more sources; processing, by the one or more processors, the plurality of data to select one or more relevant variables; training, by the one or more processors, one or more prediction models based on the one or more relevant variables, and a combination of an advanced statistical model and a machine-learning model; evaluating, by the one or more processors, performance of the one or more trained prediction models based on one or more validation techniques; and deploying, by the one or more processors, at least one prediction model based on the performance for generating one or more predictions.

In some embodiments, a system includes: one or more processors of a computing system; and at least one non-transitory computer readable medium storing instructions which, when executed by the one or more processors, cause the one or more processors to perform operations including: receiving a plurality of data from one or more sources; processing the plurality of data to select one or more relevant variables; training one or more prediction models based on the one or more relevant variables, and a combination of an advanced statistical model and a machine-learning model; evaluating performance of the one or more trained prediction models based on one or more validation techniques; and deploying at least one prediction model based on the performance for generating one or more predictions.

In some embodiments, a non-transitory computer readable medium storing instructions which, when executed by one or more processors of a computing system, cause the one or more processors to perform operations including: receiving a plurality of data from one or more sources; processing the plurality of data to select one or more relevant variables; training one or more prediction models based on the one or more relevant variables, and a combination of an advanced statistical model and a machine-learning model; evaluating performance of the one or more trained prediction models based on one or more validation techniques; and deploying at least one prediction model based on the performance for generating one or more predictions.

It is to be understood that both the foregoing general description and the following detailed description are example and explanatory only and are not restrictive of the detailed embodiments, as claimed.

### BRIEF DESCRIPTION OF THE DRAWINGS

The accompanying drawings, which are incorporated in and constitute a part of this specification, illustrate various example embodiments and together with the description, serve to explain the principles of the disclosed embodiments.

FIG. 1 introduces a capability to implement advanced statistical models and machine-learning algorithms to generate predictions, according to aspects of the disclosure.

FIG. 2A is a flow diagram that illustrates a machine-learning-enhanced forecasting pipeline, according to aspects of the disclosure.

FIG. 2B is a diagram that illustrates the data preparation step of the machine-learning-enhanced forecasting pipeline, according to aspects of the disclosure.

FIG. 2C is a diagram that illustrates the necessity of the forecast exogenous stage of the machine-learning-enhanced forecasting pipeline, according to aspects of the disclosure.

FIG. 2D is a diagram that illustrates one or more criteria to choose model inputs during the forecast exogenous stage of the machine-learning-enhanced forecasting pipeline, according to aspects of the disclosure.

FIG. 2E is a diagram that illustrates the Homados component of the machine-learning-enhanced forecasting pipeline, according to aspects of the disclosure.

FIG. 2F is a diagram that illustrates the train model step of the machine-learning-enhanced forecasting pipeline, according to aspects of the disclosure.

FIG. 2G is a diagram that illustrates the train model stage of the pipeline for capturing and forecasting time series data, according to aspects of the disclosure.

FIG. 2H is a diagram that illustrates the train model stage of the pipeline where the LSTM network is utilized, according to aspects of the disclosure.

FIG. 2I illustrates a train model phase of the pipeline that utilizes a diverse array of models to ensure robust and accurate forecasting, according to aspects of the disclosure.

FIG. 2J is a diagram that illustrates the productionize stage of the machine-learning-enhanced forecasting pipeline, according to aspects of the disclosure.

FIGS. 2K-2R are diagrams that illustrate the predict stage of the machine-learning-enhanced forecasting pipeline, according to aspects of the disclosure.

FIG. 2S is a diagram that illustrates the predict stage of the machine-learning-enhanced forecasting pipeline, according to aspects of the disclosure.

FIGS. 2T-2W are diagrams that illustrate the comparison of a forecasting model's predictive accuracy against actual sales data and status quo, according to aspects of the disclosure.

FIG. 3 is a flowchart of a process for adaptive forecasting using advanced statistical models and machine-learning models, according to aspects of the disclosure.

FIG. 4 shows an example machine learning training flow chart.

FIG. 5 illustrates an implementation of a computer system that executes techniques presented herein.

### DETAILED DESCRIPTION OF EMBODIMENTS

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description.

Various non-limiting embodiments of the present disclosure will now be described to provide an overall understanding of the principles of the structure, function, and use of an advanced forecasting system. These embodiments may encompass the integration of machine-learning algorithms, such as Long Short Term Memory (LSTM) and Random Forests, with statistical methods like ARIMA and Exponential Smoothing, to predict future values and precision. Additionally, the embodiments detail the implementation of automated data pipelines, on-demand forecasting capabilities, scalable architectures, anomaly detection, and exogenous variable forecasting.

Conventional forecasting models often fail to account for the inherent variability in demand, resulting in overly simplistic forecasts that do not adequately capture fluctuations caused by factors like external events (e.g., economic disruptions). The conventional forecasting models are technically challenged to include mechanisms for regular updates, resulting in forecasts that quickly become outdated as new data emerges. The conventional forecasting models also tend to perform poorly under extreme market conditions (e.g., pandemic or sudden spike in demand) due to their reliance on stable historical patterns. The conventional forecasting approaches often lack the capacity to learn from new data inputs in an automated manner, requiring manual recalibration to adjust to new trends and patterns.

The conventional forecasting approaches typically rely on pre-defined structures that may not be flexible enough to adapt to changing data patterns, limiting their ability to improve over time. The conventional forecasting methods are technically challenged to incorporate categorical variables (e.g., product categories, customer segments) leading to oversimplified forecasts that do not capture the full complexity of patterns. Such conventional forecasting models are sensitive to noise and anomalies in the data, which may skew results and lead to inaccuracies.

To address the limitations of the conventional forecasting models, system 100 may utilize advanced machine-learning algorithms for capturing complex, non-linear relationships in data to improve the accuracy of the forecasting models. The system 100 may integrate diverse datasets (e.g., economic indicators, market sentiment, or social media trends), for accurate predictions, adjusting dynamically as new data becomes available. The system 100 may efficiently handle large datasets using distributed computing and parallel processing, ensuring scalability. The system 100 may automatically learn and adapt from new data, continuously improving its predictive accuracy. By capturing cyclic trends and latent variables, the system 100 may provide a granular, dynamic view of the demand for each product, enabling precise allocation of production resources to reduce surpluses and mitigate shortages effectively. The system 100 may integrate time series modeling and machine-learning models for capturing complex temporal patterns and interdependencies inherent in the data. By combining historical data with data streams, the prediction models may generate forecasts that adapt dynamically to changing market dynamics. This integrated approach may enhance the accuracy of predictions but also facilitates agile decision-making in resource allocation, effectively optimizing productions to minimize surpluses and alleviate shortages.

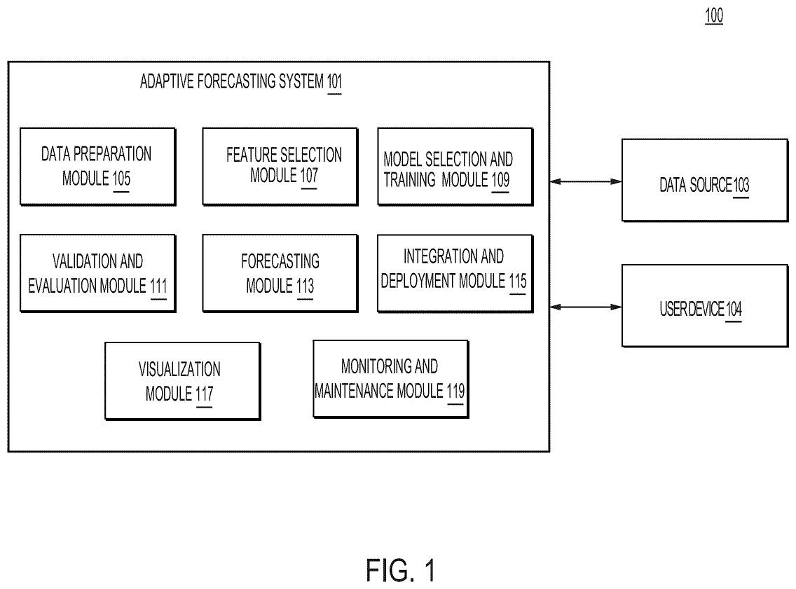

FIG. 1 introduces a capability to implement advanced statistical models and machine-learning algorithms to generate predictions, according to aspects of the disclosure. FIG. 1, an example architecture of one or more example embodiments of the present disclosure, includes the system 100 which comprises an adaptive forecasting system 101 and data source 103.

In one embodiment, the adaptive forecasting system 101 may be a platform with multiple interconnected components. The adaptive forecasting system 101 may include one or more servers, intelligent networking devices, computing devices, components, and corresponding software for utilizing advanced statistical models and machine-learning algorithms to generate predictions. In addition, it is noted that the adaptive forecasting system 101 may be a separate entity of the system 100.

The adaptive forecasting system 101 may aggregate and clean data from various sources, handle missing values, normalize data, and perform feature engineering to prepare high-quality input for the prediction models (i.e., forecasting models). The adaptive forecasting system 101 may identify and select the most relevant feature using statistical and machine-learning techniques, ensuring that only significant variables are included in the prediction models to enhance accuracy. The adaptive forecasting system 101 may train a plurality of prediction models such as ARIMA, LSTM, and tree-based models, and optimize their hyperparameters using techniques like Bayesian optimization to achieve the best performance. The adaptive forecasting system 101 may conduct rigorous validation using cross-validation and backtesting, and may evaluate model performances with various metrics to ensure robustness and prevent overfitting. The adaptive forecasting system 101 may deploy the best-performing prediction models into production, integrate them with business systems, and continuously monitor their performance, making necessary adjustments to maintain accuracy and reliability. For example, the adaptive forecasting system 101 may implement on-demand forecasting capabilities to generate up-to-date predictions based on the latest data, and continuously update the prediction models as new data becomes available to maintain accuracy and relevance in dynamic market conditions. The adaptive forecasting system 101 may utilize scalable architecture and parallel processing techniques to handle large volumes of data and expedite training and evaluation of the prediction models. The adaptive forecasting system 101 may incorporate forecasting of exogenous variables, such as economic indicators and market trends to enhance model inputs and improve the accuracy of predictions. Additionally or alternatively, the adaptive forecasting system 101 may integrate anomaly detection mechanisms to identify, and handle outliers or unusual patterns in the data.

In one instance, data source 103 may include a variety of internal and external data sources that may provide comprehensive insights into past and future trends. In one instance, internal data sources may include historical sales data, inventory levels, and customer transaction, which may be stored in a database (e.g., customer relationship management (CRM) database) or enterprise resource planning (ERP) system. In one instance, external data sources may encompass market trends, economic indicators, social media sentiments, and weather data, which may be accessed through public databases, third-party providers, and APIs. In one instance, these diverse data inputs may be integrated into a centralized database or data warehouse to ensure that all relevant information is available for analysis. By consolidating these data sources into a unified system, the adaptive forecasting system 101 may leverage advanced analytics and machine-learning techniques to generate accurate and actionable forecasts.

In one instance, the adaptive forecasting system 101 may comprises a data preparation module 105, a feature selection module 107, a model selection and training module 109, a validation and evaluation module 111, a forecasting module 113, an integration and deployment module 115, a visualization module 117, a monitoring and maintenance module 119, or any combination thereof. As used herein, terms such as “component” or “module” generally encompass hardware and/or software, e.g., that a processor or the like used to implement associated functionality. It is contemplated that the functions of these components are combined in one or more components or performed by other components of equivalent functionality.

In one instance, data preparation module 105 may collect relevant data through various data collection techniques from various data sources (e.g., data source 103). In one example, the data preparation module 105 may use a web-crawling component to access data source 103 to collect the relevant data. In one example, the data preparation module 105 may include various software applications (e.g., data mining applications in Extended Meta Language (XML)) that automatically search for and return relevant data. Once collected, the data may undergo a rigorous preprocessing phase to ensure it is clean, consistent, and ready for analysis. This may involve handling missing values, which may be filled using various imputation methods, and addressing inconsistencies or errors in the data. Additionally, the preprocessing stage may include feature engineering, where new features may be created to enhance the predictive power of the models, and data transformation, such as normalization and smoothing, to ensure data is in a suitable format for model training. By thoroughly preparing the data, the data preparation module 105 lays a robust foundation for accurate and reliable forecasting.

In one instance, feature selection module 107 may identify the relevant and influential variables from the dataset that should be included in the prediction model. The feature selection module 107 may perform a comprehensive analysis of the dataset, considering both historical and exogenous features such as sales figures, inventory levels, economic indicators, and weather data. Advanced statistical methods and machine-learning techniques, such as correlation analysis, mutual information, and recursive feature elimination may be employed to evaluate the importance of each feature. The feature selection module 107 may retain features that may significantly contribute to the model's predictive accuracy while eliminating those that add noise or redundancy. This may enhance the prediction model's performance and may reduce computational complexity.

In one instance, model selection and training module 109 may identify suitable prediction models and may fine-tune them to achieve optimal performance. The model selection and training module 109 may evaluate various forecasting models, such as ARIMA, Seasonal Autoregressive Integrated Moving Average With Exogenous Variables (SARIMAX), Facebook Prophet, LSTM, and tree-based models like Random Forests or Gradient Boosting Machines, to determine which are best suited to the characteristics of the data and the forecasting objectives. Once the prediction models are selected, the training phase may include feeding the preprocessed data into these models and adjusting their parameters to improve accuracy. This process may include hyperparameter tuning, which may be automated and parallelized using techniques such as Bayesian optimization with tools like Hyperopt. In one example, in an LSTM model, hyperparameters like the number of layers, the number of units per layer, and the learning rate may be tuned. In one example, in tree-based models, parameters such as the depth of the trees, the number of trees, and the minimum samples per leaf may be adjusted. The training phase is iterative, involving continuous assessment and refinement based on validation datasets to ensure the models generalize to unseen data. In one instance, advanced machine-learning techniques such as cross-validation, ensemble methods, and neural networks may be leveraged to build robust models capable of capturing complex patterns and relationships in the data.

In one instance, validation and evaluation module 111 may implement machine-learning techniques to ensure reliability and accuracy of the prediction models. The validation and evaluation module 111 may perform a rigorous assessment of the trained models using separate validation datasets that were not part of the training process, providing an unbiased evaluation of model performance. The validation and evaluation module 111 may utilize advanced machine-learning techniques to perform cross-validation, where the data is split into multiple folds, and the model is trained and validated on different subsets to ensure robustness and prevent overfitting. The evaluation process may involve backtesting, where historical data may be used to simulate the forecasting performance in a real-world scenario. By thoroughly validating the models, the validation and evaluation module 111 may identify any biases and may facilitate further refinement and tuning. Such validation and evaluation processes may ensure the models are highly accurate and also generalizable to new data.

In one instance, forecasting module 113 may generate accurate predictions of future demand based on historical data and other relevant factors. The forecasting module 113 may leverage advanced statistical methods and machine-learning algorithms to analyze patterns and trends in the data and extrapolate them into the future. In one instance, time series forecasting techniques such as ARIMA, SARIMA, and exponential smoothing may be commonly used to model the temporal dependencies in the data and make short-term predictions. For longer-term forecasts and scenarios involving complex relationships, machine-learning models like LSTM neural networks, Gradient Boosting Machines, and Random Forests may be employed. These models may capture nonlinear relationships and interactions among multiple variables, resulting in accurate predictions. In one instance, the forecasting module 113 may also consider external factors such as market trends, economic indicators, and seasonal patterns to enhance the accuracy of the forecasts. In one example, by continually monitoring model performance and incorporating feedback from actual sales data, this module ensures that the forecast remains up-to-date and reliable.

In one instance, integration and deployment module 115 may facilitate the integration of the prediction models and associated data pipelines into existing business systems (e.g., enterprise resource planning (ERP), supply chain management (SCM), CRM, etc.). By integrating with these systems, the prediction models may leverage relevant data sources and provide insights directly to the decision-makers. The integration and deployment module 115 may manage the deployment of the prediction models into production environments, ensuring scalability, reliability, and performance. This may involve setting up automated workflows for data ingestion, preprocessing, model training, validating, and forecasting, as well as implementing monitoring and alerting systems to detect and address any issues.

In one instance, visualization module 117 may provide a visual representation of forecasted results and trends. The visualization module 117 may utilize various visualization techniques, including charts, graphs, dashboards, and heatmaps, to present forecasted data in a clear and meaningful way. In one example, a time series plot may illustrate historical sales trends and forecasted values over time, while scatter plots may reveal correlations between different variables. In one example, interactive dashboards may allow users to explore forecasted results from different perspectives and drill down into specific regions or product categories. The visualization module 117 may enable the comparison of multiple forecast scenarios, aiding in scenario planning and risk management. By providing actionable insights in a visually appealing format, this module may enhance the usability and effectiveness of the forecasting system.

In one instance, monitoring and maintenance module 119 may continuously monitor the accuracy and effectiveness of the deployed models in generating forecasts by comparing predicted values with actual outcomes. Any deviation or discrepancies are promptly identified and investigated, allowing for timely adjustments and refinements to the models. In one example, the monitoring and maintenance module 119 may track various performance metrics to gauge the overall effectiveness of the prediction models. In one example, regular maintenance tasks, such as model retraining and updating, may be conducted to ensure the models remain relevant and adaptable to changing market conditions. In addition, the monitoring and maintenance module 119 may incorporate feedback loops from stakeholders and end-users to gather insights and suggestions for improving the forecasting process.

The above presented modules and components of the adaptive forecasting system 101 may be implemented in hardware, firmware, software, or a combination thereof. The various executions presented herein contemplate any and all arrangements and models.

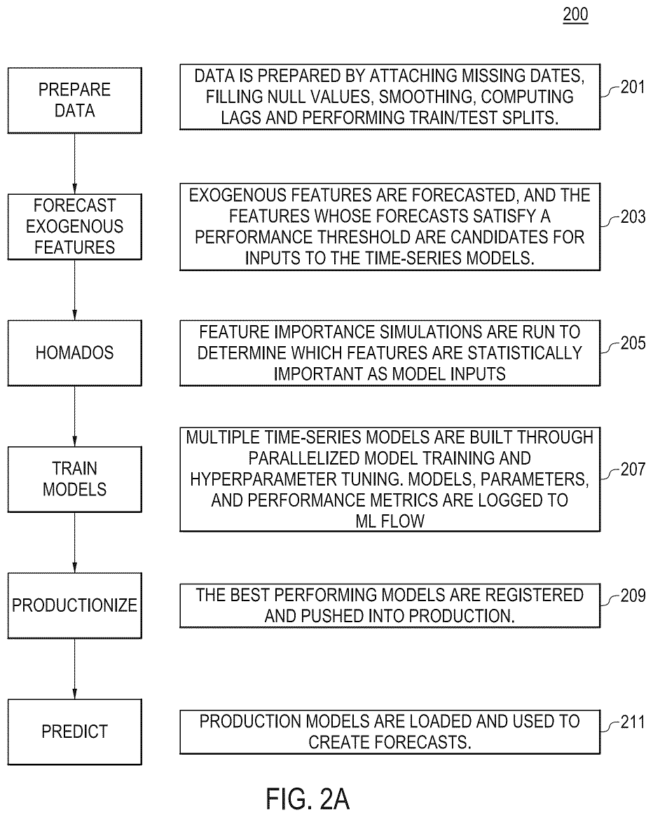

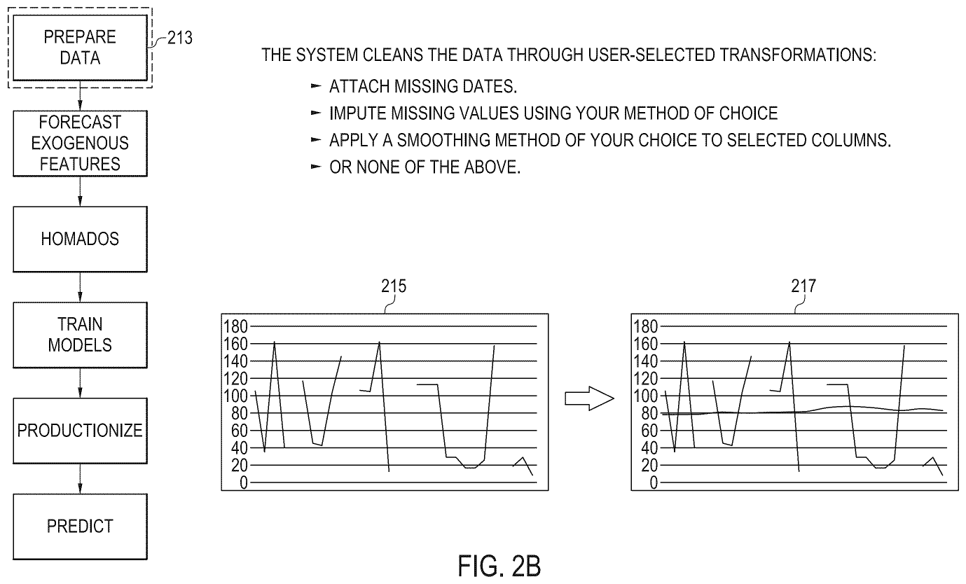

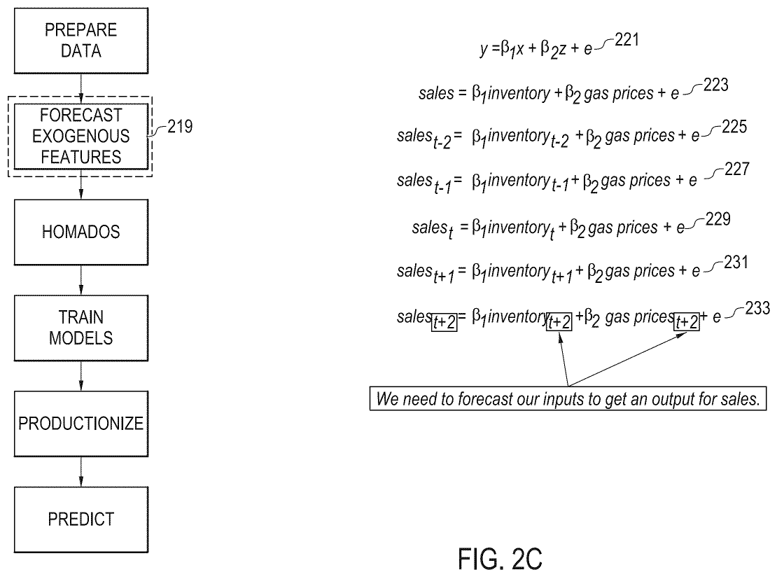

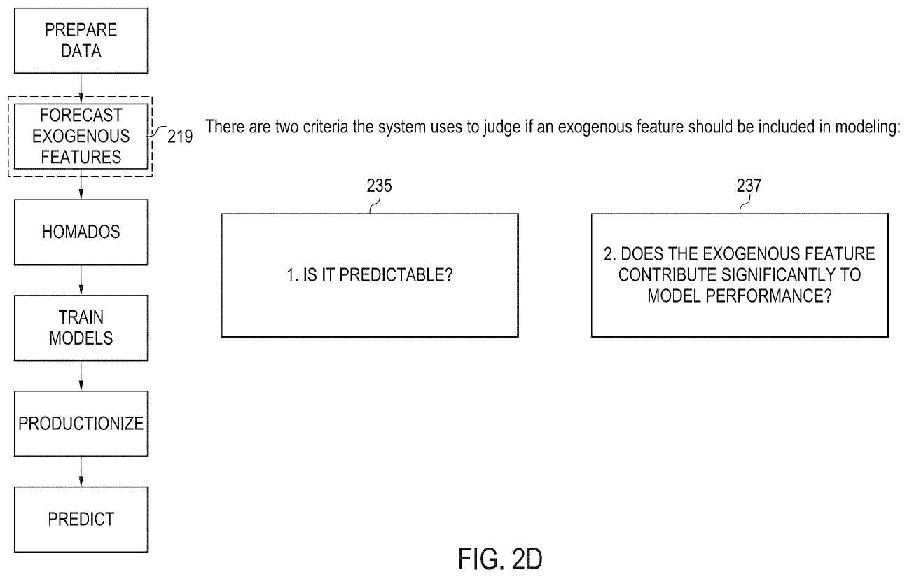

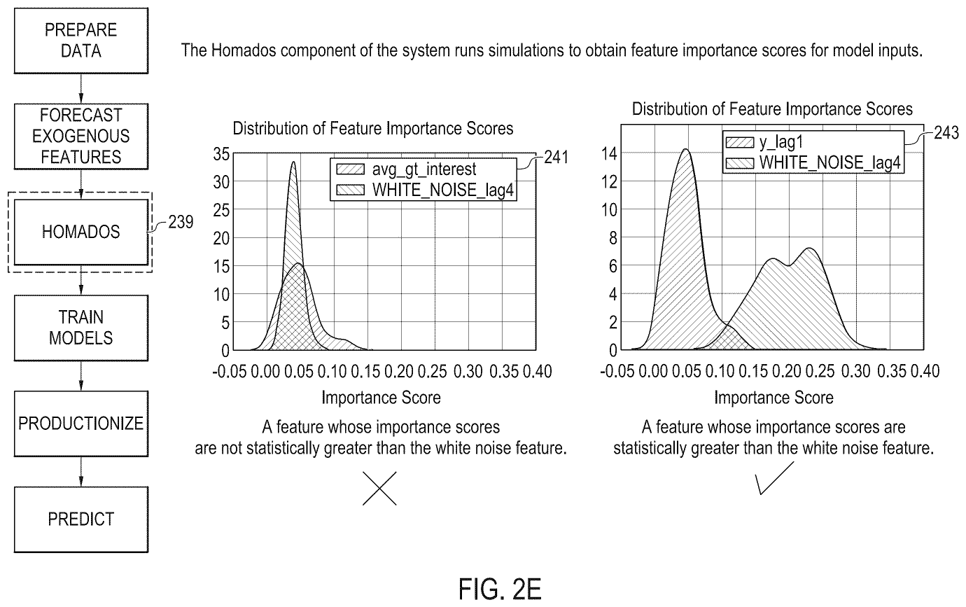

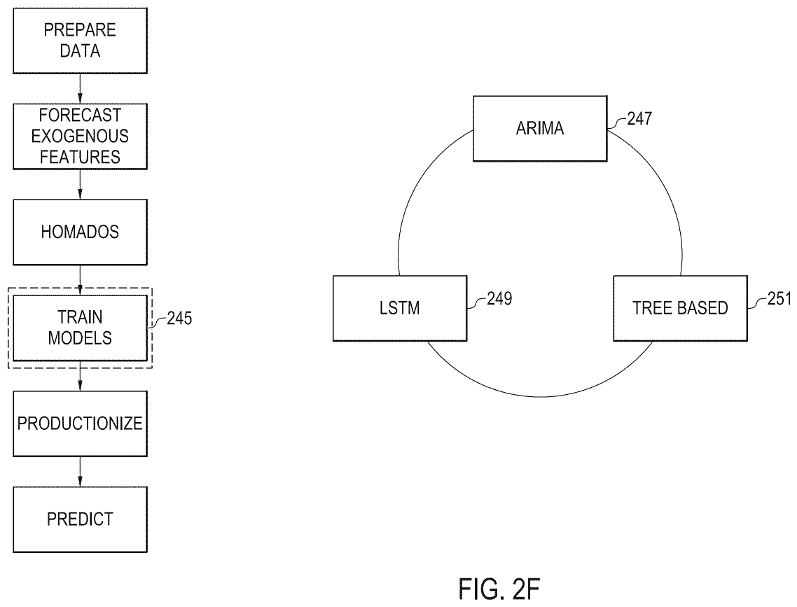

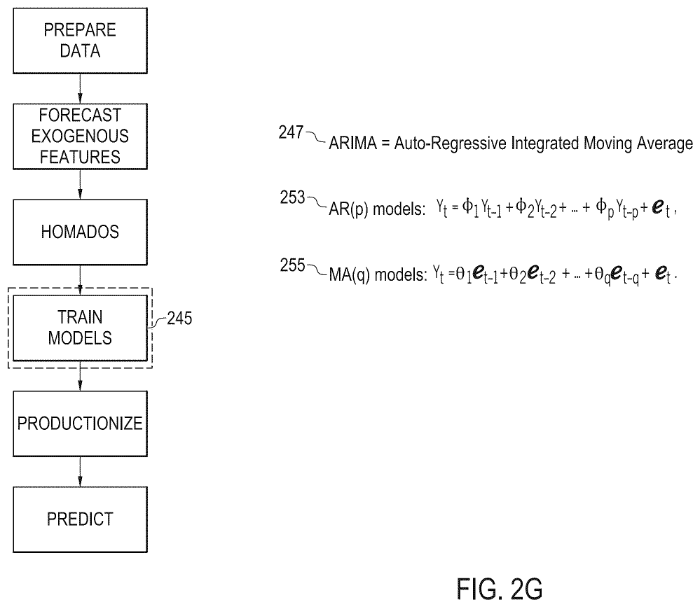

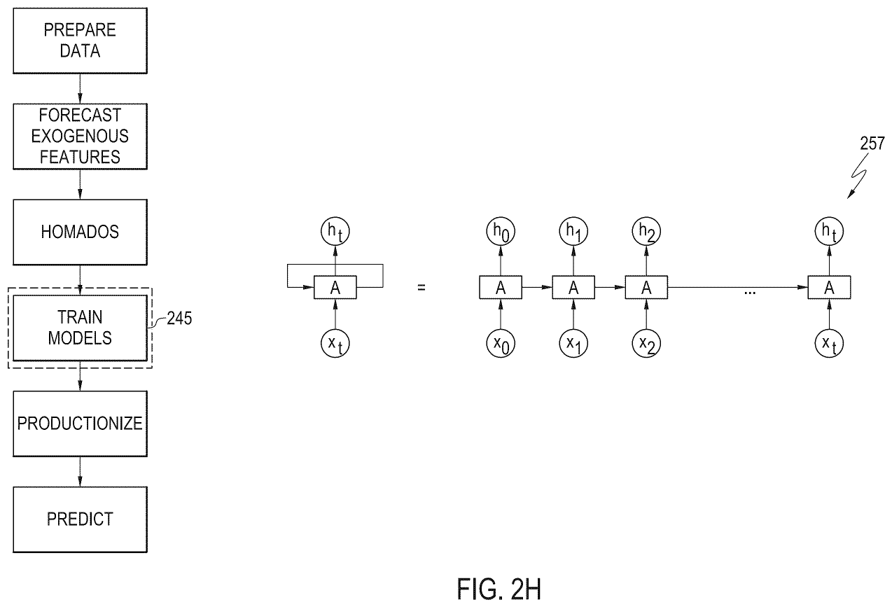

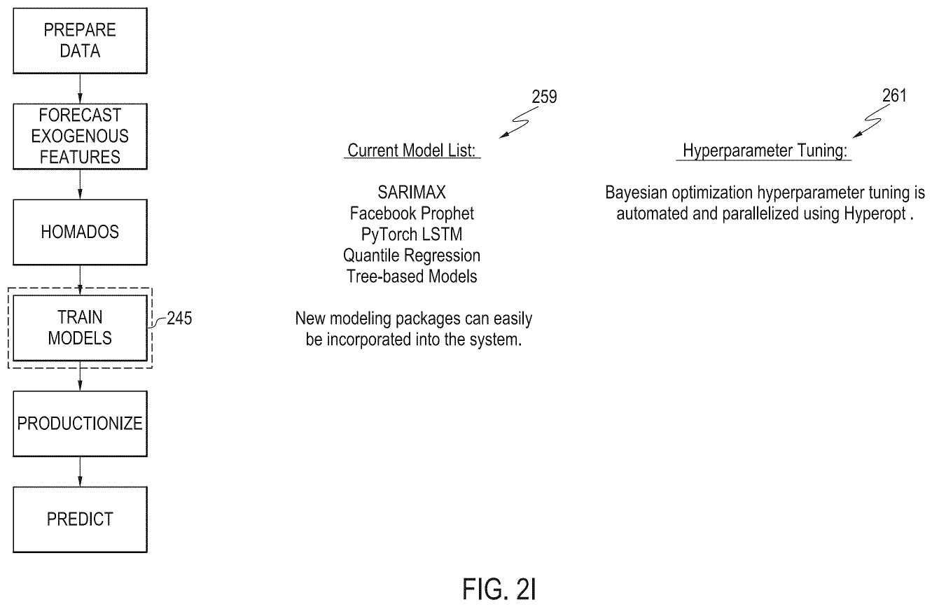

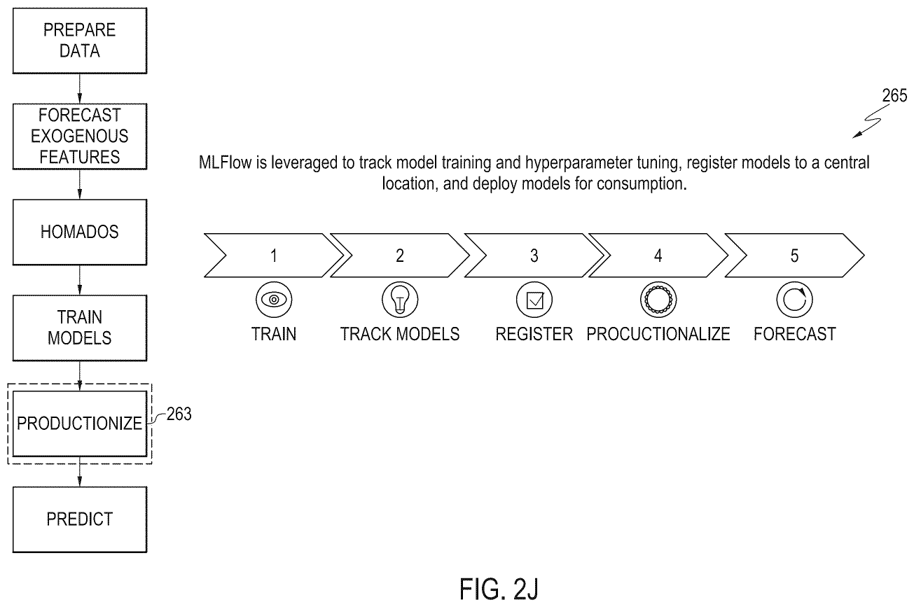

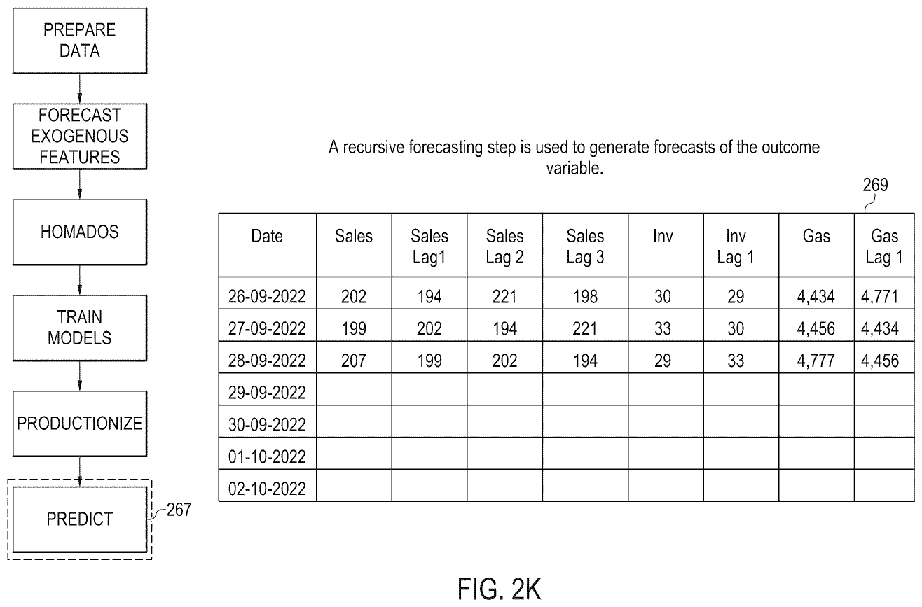

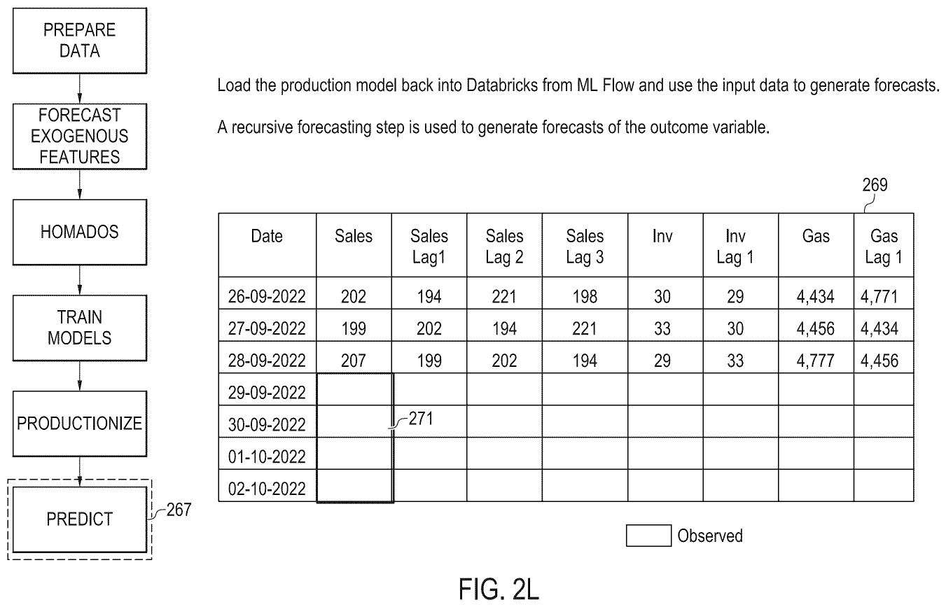

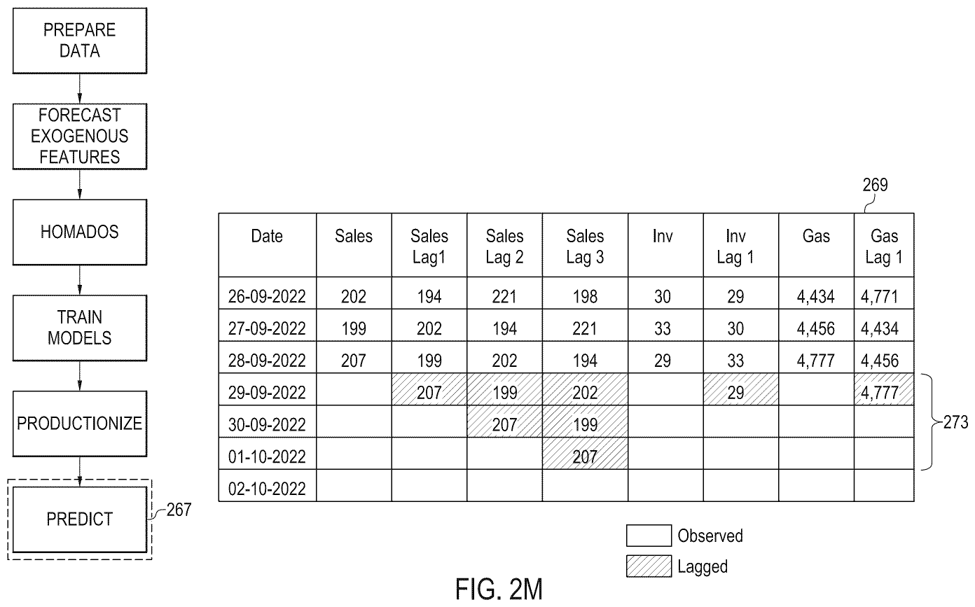

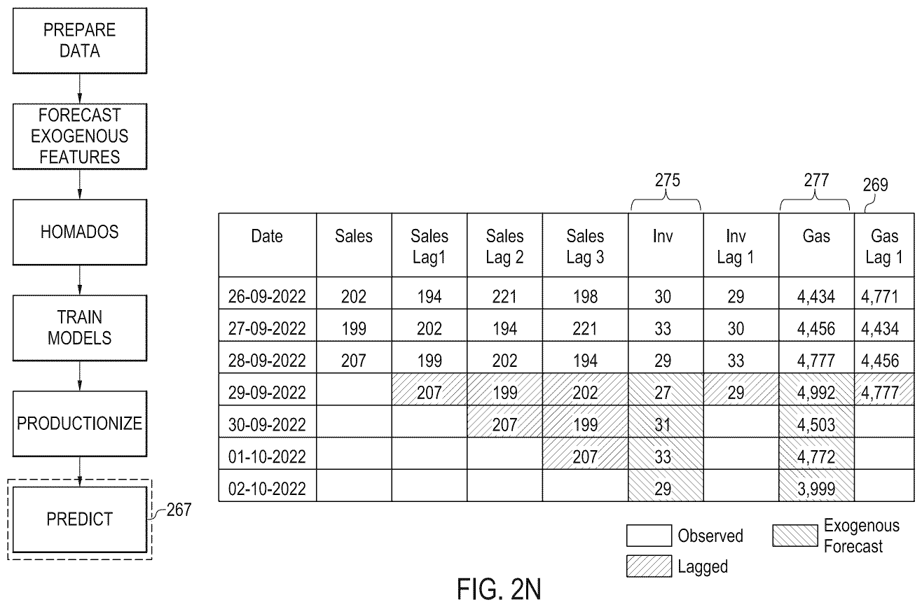

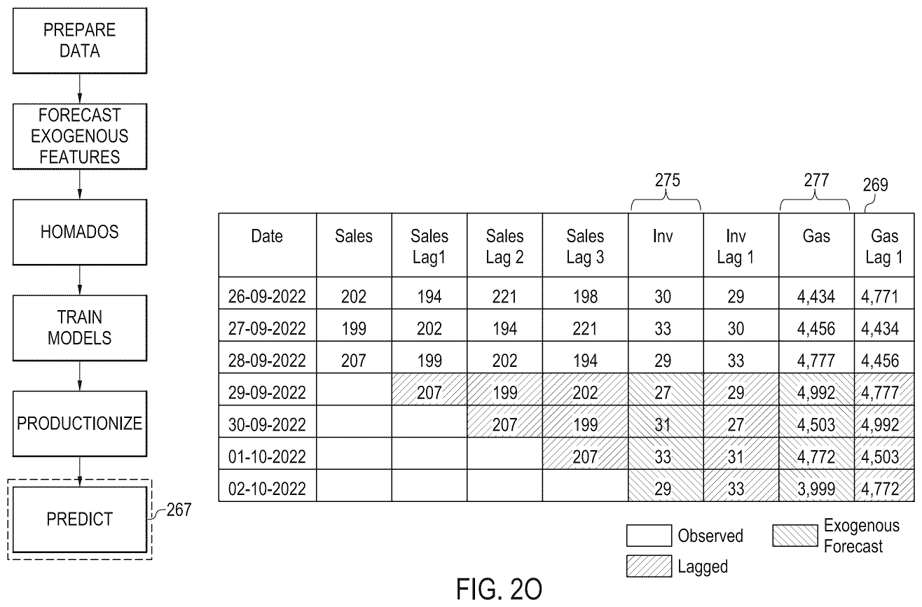

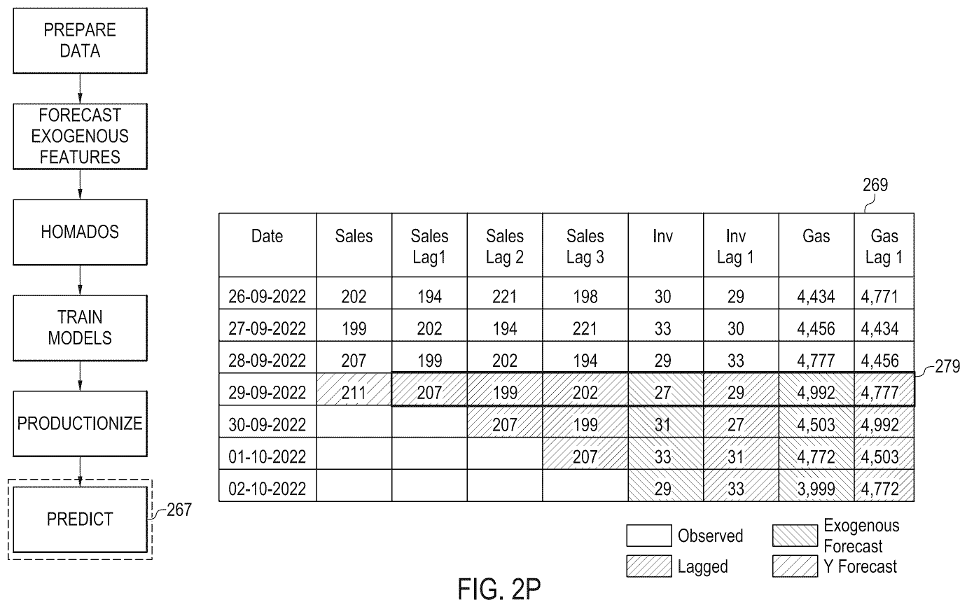

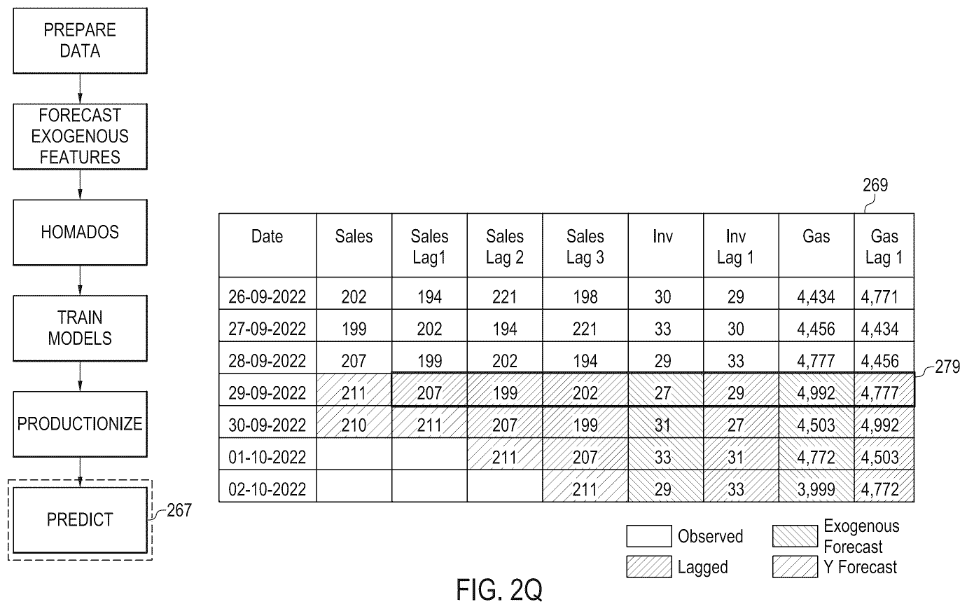

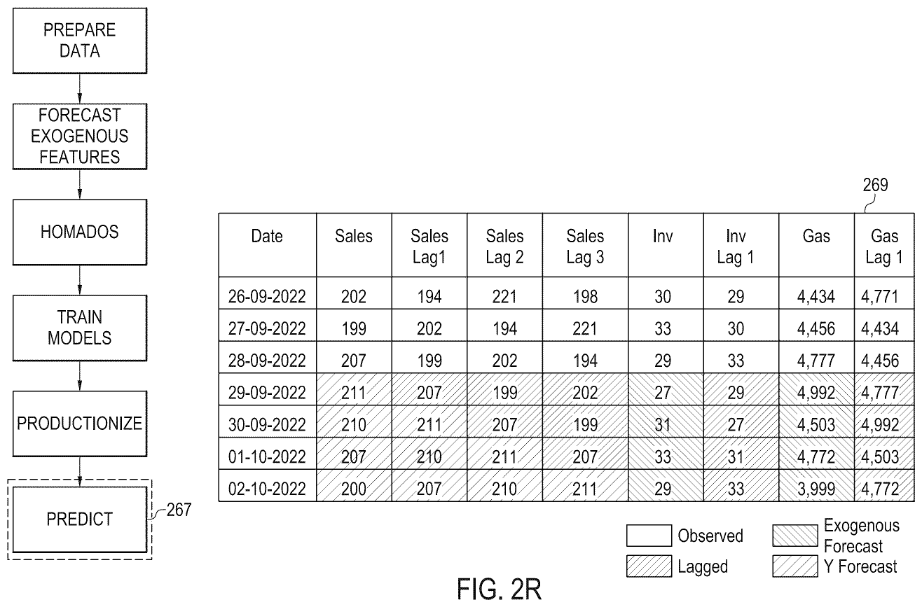

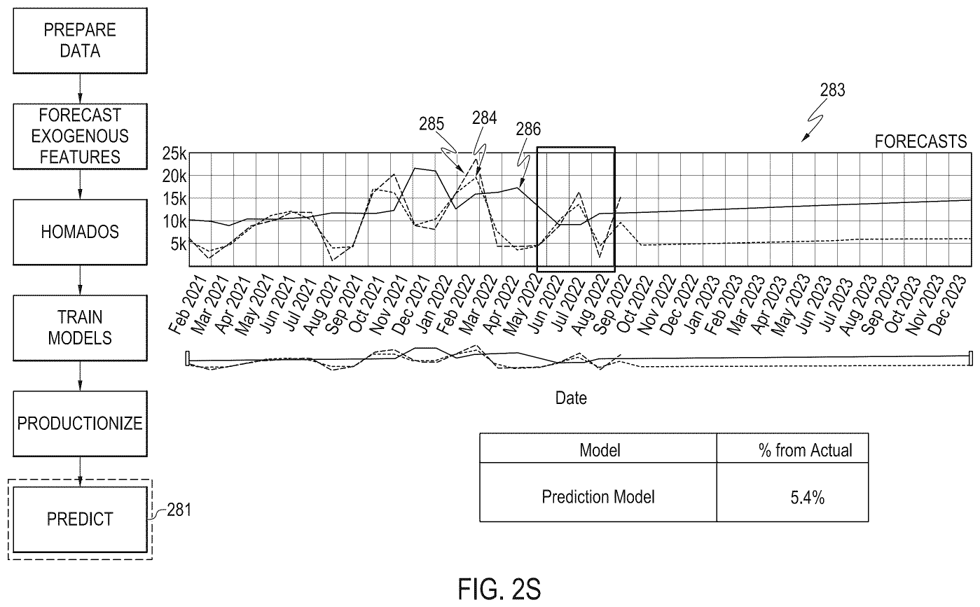

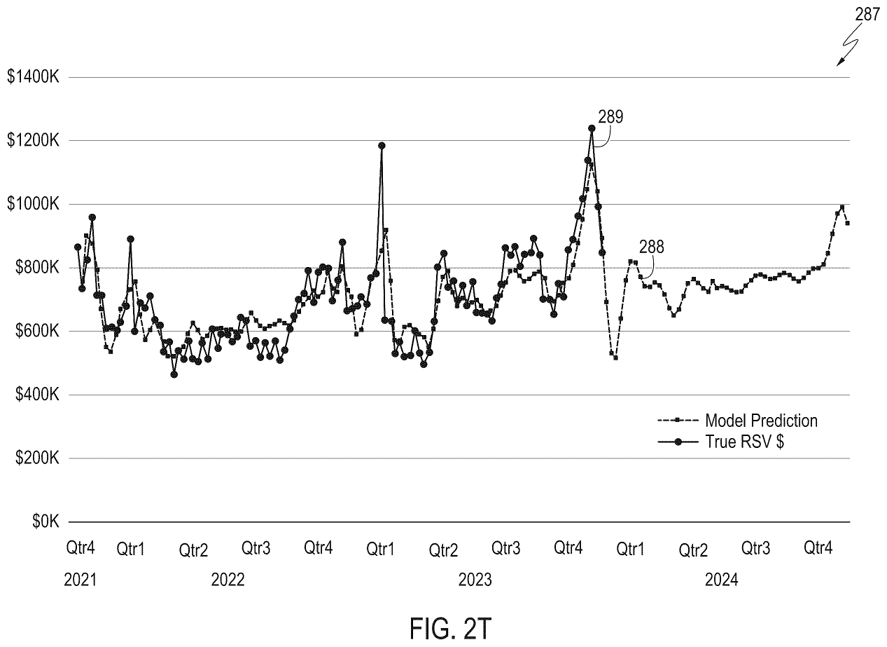

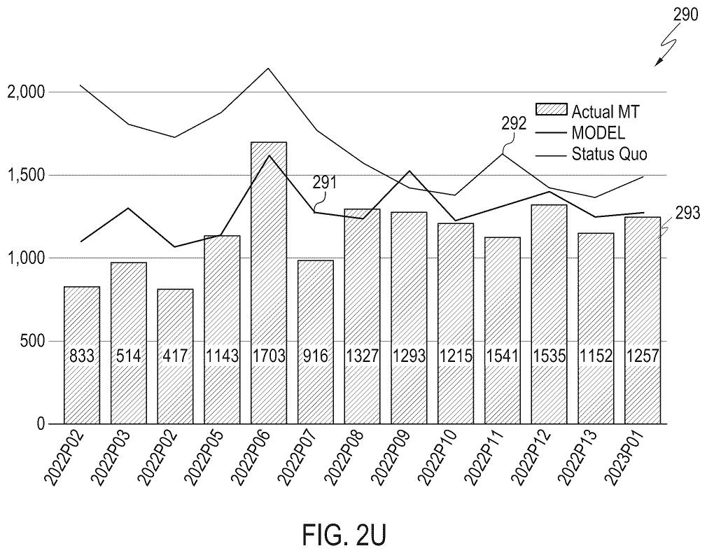

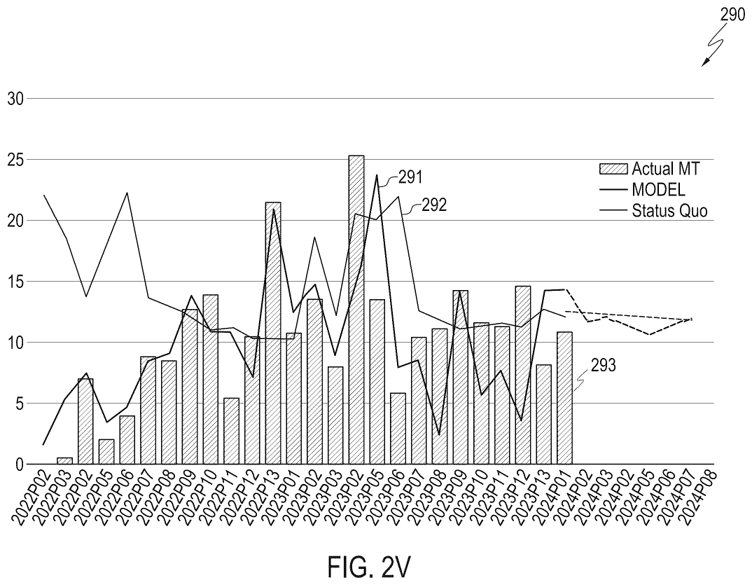

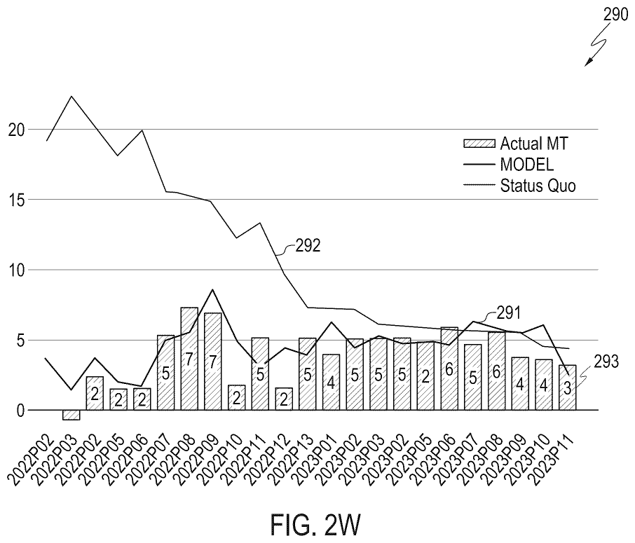

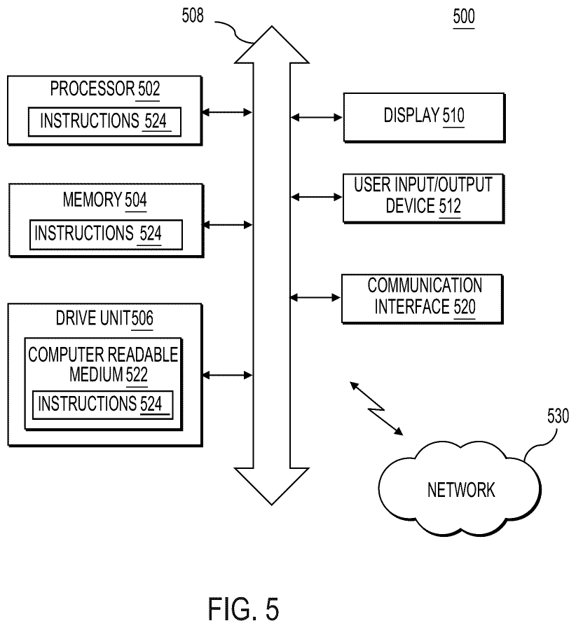

FIGS. 2A-2S are diagrams that illustrate a machine-learning-enhanced forecasting pipeline, according to aspects of the disclosure. In various embodiments, the adaptive forecasting system 101 and/or any of the modules 103-111 may perform one or more processes in FIGS. 2A-2S and are implemented using, for instance, a chip set including a processor and a memory as shown in FIG. 5. As such, the adaptive forecasting system 101 and/or any of the modules 103-111 provide means for accomplishing various parts of FIGS. 2A-2S, as well as means for accomplishing embodiments of other processes described herein in conjunction with other components of the system 100.

FIG. 2A is a flow diagram that illustrate a forecasting workflow 200 using machine learning, according to aspects of the disclosure. In one instance, the forecasting workflow 200 may be an end-to-end pipeline that may take a base time-series data frame and may produce accurate models.

In block 201, in preparing the data for analysis, several crucial steps are undertaken to ensure its quality and usability. Initially, missing dates are addressed by appending them to the dataset, ensuring comprehensive temporal coverage. Null values are then filled using appropriate techniques, such as imputation or interpolation, to maintain data integrity. Smoothing methods, such as moving averages or exponential smoothing, may be applied to reduce noise and reveal underlying trends in the data. Additionally, computed tags, such as seasonality indicators or trend components are incorporated to provide further insights into the underlying patterns. Finally, the dataset is divided into training and testing sets to facilitate model development and evaluation, ensuring that the predicating algorithms generalize well to unseen data.

In block 203, in forecasting tasks, exogenous features play a crucial role in enhancing the predictive capabilities of time series models. These features, often external to the primary datasets are forecasted independently using appropriate methods, such as machine-learning algorithms or statistical models. Subsequently, a performance threshold is established to assess the quality of these forecasts, ensuring they meet predefined criteria for accuracy and reliability. Feature whose forecasts surpass this threshold are deemed suitable candidates for inclusion as inputs to the time series model. By incorporating these exogenous factors, which may capture external influences such as economic indicators or market trends, the time series model gains additional explanatory power and can generate more robust and accurate predictions.

In block 205, in predictive modeling, particularly in machine-learning, feature importance simulation plays a crucial role in identifying the most relevant variable for inclusion as model inputs. These simulations involve systematically evaluating the impact of each feature on the model's performance. By iteratively assessing the model's performance with and without specific features, statistical methods determine the relative importance of each variable in explaining the target variable's variance. Features that consistently demonstrate a substantial influence on the model's predictive accuracy are deemed statistically important and are prioritized as inputs to the final model.

In block 207, multiple time series models are developed through a process of parallelized model training and hyperparameter tuning. This approach leverages parallel computing to simultaneously train a variety of models, such as ARIMA and LSTM networks, each with different configurations of hyperparameters. By exploring a broad range of model structures and parameter settings, this method identifies the most effective combinations for accurate forecasting. Throughout this process, all models, their corresponding hyperparameters, and performance metrics are meticulously logged using ML flow (an open-source platform for managing the machine-learning life cycle). ML flow facilitates the tracking of experiment results, enabling easy comparison and selection of the best-performing models.

In block 209, once the best performing models are identified through rigorous evaluation and hyperparameter tuning, they are pushed into production. This deployment phase involves integrating the selected models into the operational environment where they can process data and generate accurate forecasts. These models are continuously monitored to ensure they maintain their performance and accuracy in the dynamic environment.

In block 211, the deployed models are loaded and utilized to generate on-demand forecasts. These models, having been rigorously validated and tuned, process incoming data to predict future patterns accurately. The forecasts produced are then used to inform decision-making processes, enabling timely adjustments in production schedules, inventory management, and resource allocation.

FIG. 2B is a diagram that illustrates the data preparation step 213 of the machine-learning-enhanced forecasting pipeline, according to aspects of the disclosure. In one instance, the adaptive forecasting system 101 may clean the data through user-selected transformations, offering flexibility to address various data quality issues. Users may choose to attach missing dates to ensure temporal continuity, impute missing values using their preferred method (such as mean, median, or advanced imputation techniques), and apply a smoothing method of their choice to selected columns to reduce noise and highlight trends. Additionally, users have the option to bypass these transformations if deemed unnecessary. This customizable approach ensures the data is accurately prepared according to specific needs and preferences.

In one instance, the adaptive forecasting system 101 may generate a raw table containing time series data. The time series data may include a date column, columns that form groups (e.g., a Customer-SKU pair), a target variable column, and columns of additional features (e.g., exogenous features). If a customer skips a week between orders or exhibits highly erratic order behavior (e.g., very high values followed by very low values), such events can lead to poor performance in forecasts. To mitigate this, standard time series data preprocessing and cleaning are performed, ensuring the data is well structured and ready for accurate analysis and forecasting.

In one example, chart 215 depicts time series data that may be difficult to model. There are missing values or the values are very erratic (e.g., high variance), and in modeling frameworks, there should not be any missing values. The conventional methods may replace the missing values with 0, but then the series may look disordered. The conventional methods may also fill in the missing values with the previous values or averages of previous values, but then the series may look very spikey. Hence, the adaptive forecasting system 101 may implement a variety of smoothing techniques (e.g., replacing values with averages of the previous 7 days or 14 days of data) to make the series more interpretable and easier to model (e.g., chart 217).

FIG. 2C is a diagram that illustrates the forecast exogenous feature stage 219 of the machine-learning-enhanced forecasting pipeline, according to aspects of the disclosure. In the forecast exogenous feature stage 219, the focus lies on generating predictions for external factors that may influence the forecast. These exogenous features, which may encompass variables such as economic indicators, weather patterns, or marketing campaigns, play a pivotal role in enhancing the accuracy and granularity of the prediction model. Leveraging advanced forecasting techniques, such as machine learning algorithms or statistical models, these features are forecasted independently to capture their potential impact on future trends.

In one instance, after the initial data preparation phase, the adaptive forecasting system 101 may proceed to identify the optical model architecture and determine the best set of model inputs. Given that the prepared dataset may include voluminous data, the system undertakes an automated approach to select only the exogenous features that are relevant and worthy of inclusion as inputs for the prediction models. Through this automated feature selection process, the adaptive forecasting system 101 may aim to streamline the modeling process and enhance the model's predictive accuracy by focusing solely on the most impactful variables. During this process, the adaptive forecasting system 101 may perform various calculations to determine the optimal architecture and feature set, for example:
Equation 221 is a simple linear model for y. It has two input variables x and z, coefficients beta1 (β₁), and beta2 (β₂), and a constant error term e.
Equation 223 is a simple linear model for sales (i.e., y). It has two input variables inventory and gas prices, coefficients beta1 (β₁), and beta2 (β₂), and a constant error term e. Inventory and gas prices are examples of exogenous features, as they are external to sales.
Equation 225, except for the constant error term e, the terms in this equation vary with time. For example, sales today is a multiple of today's inventory plus a multiple of today's gas prices plus a constant term e.

Suppose that today is day t, the equation shows that sales from 2 days ago (today-2) are equal to a combination of inventory from 2 days ago and gas prices 2 days ago.
Equation 227, sales from 1 day ago are equal to a combination of inventory from 1 day ago and gas prices from 1 day ago.
Equation 229, today's sales are a combination of today's inventory and today's gas prices. The values for sales, inventory, and gas prices up to today, which is time t. The machine learning algorithms may find the best values for the constant coefficients beta1 (β₁), beta2 (β₂), and the error term e. To get any use of this sales model, the adaptive forecasting system 101 may utilize it to predict sales for times in the future.
Equation 231, to use the model to predict tomorrow's sales, the adaptive forecasting system 101 may plug in values for tomorrow's inventory and tomorrow's gas prices.
Equation 233, to get a predicted value for sales 2 days from now, the adaptive forecasting system 101 may plug in values for inventory and gas prices for 2 days from now. To do that, the adaptive forecasting system 101 may have forecasts for tomorrow and for the next day for the exogenous variables.

Through iterative optimization techniques, the adaptive forecasting system 101 may evaluate different combinations of features and model structures to identify the configuration that yields the most accurate and robust forecasts. This meticulous calculation process ensures that the final model architecture effectively captures the underlying relationships within the data, enabling precise predictions of future patterns.

FIG. 2D is a diagram that illustrates one or more criteria to choose model inputs during the forecast exogenous stage of the machine-learning-enhanced forecasting pipeline, according to aspects of the disclosure. In one instance, the adaptive forecasting system 101 may evaluate potential external factors to determine their suitability for inclusion in the prediction model. This evaluation is based on two key criteria. First, the adaptive forecasting system 101 may assess whether the exogenous feature is predictable (235), meaning it can be accurately forecasted using available data and reliable methods. Second, the adaptive forecasting system 101 may examine whether the exogenous feature contributes significantly to the model's performance (237), enhancing its accuracy and robustness. Only those features that meet both criteria by demonstrating predictability and a meaningful impact on model performance are incorporated into the final model. This selective approach ensures that the prediction model is both precise and efficient, leveraging the most relevant external factors to improve predictions.

FIG. 2E is a diagram that illustrates the Homados component 239 of the machine-learning-enhanced forecasting pipeline, according to aspects of the disclosure. The adaptive forecasting system 101 may run simulations to obtain feature importance scores for potential model inputs. This process involves creating dummy features using randomly sampled numbers to serve as a baseline for comparison. The adaptive forecasting system 101 may generate a list of features that are certain to contribute more to model performance than random noise. In one example, by running approximately 500 simulations, each involving the attachment of a white noise dummy feature sampled from different types of distributions, the adaptive forecasting system 101 may determine the feature importance scores for each potential input. Features that demonstrate statistically greater importance scores than the white noise dummies are identified as significant contributors and are included in the final models. These simulations and feature selections are determined for each unique time-series to be modeled. After the simulations are completed, a list consists of features that are certain to contribute more to model performance than random noise.

In one example, graph 241 illustrates an exogenous feature that exhibits a statistically equivalent distribution to the highest-scoring white noise feature. Both distributions are indistinguishable from each other, indicating that this exogenous feature does not provide any meaningful information or predictive power beyond what random noise would contribute. Consequently, including such a feature in the model would add no value and could potentially dilute the model's performance. In one example, graph 243 is an example of an exogenous feature (the first lag of the target, ordered units) that has statistically greater feature importance scores than the highest-scoring white noise feature. Consequently, this feature may be included in the final models. These examples underscore the importance of rigorous feature selection to ensure that only those variables with genuine predictive significance are incorporated into the final prediction model.

In one embodiment, the Homados component 239 may evaluate the importance of each predictable exogenous feature by running modeling simulations. The steps may include, but not limited to:
1. Obtain White Noise features by randomly sampling from Normal, Poisson, and Binomial distributions;
2. Compute lags of the target, predictable exogenous features, and White Noise features—these are the input features;
3. Train a random forest model using the above input features;
4. Extract the permutations feature importance scores of all input features;
5. Repeat 500 Times, then . . .
6. Create a list of all exogenous features, and lags of the target that have statistically higher feature importance scores than the highest-scoring average White Noise feature.

FIG. 2F is a diagram that illustrates the train model step of the machine-learning-enhanced forecasting pipeline, according to aspects of the disclosure. In the train model stage 245, three distinct types of models may be developed to ensure robust and accurate forecasting. The first model type is autoregressive integrated moving average (ARIMA) 247, which is effective for capturing linear temporal dependencies in time series data. In one instance, the ARIMA 247 may consist of an autoregressive component and a moving average component. Each component approaches time series modeling through a linear combination of past values of the target variable or error terms. Exogenous variables may also be included in these models (e.g., ARIMAX models). The second model type is Long Short Term Memory (LSTM) 249, a type of recurrent neural network that excels in learning and predicting complex patterns and long-term dependencies in sequential data. The third model type is tree-based model 251, such as Random Forest or Gradient Boosting Machines, which are powerful for handling non-linear relationships and interactions between features. By training these diverse models, the pipeline leverages the strengths of each approach, enhancing the overall forecasting accuracy and reliability.

ARIMA 247 is often used for short-term rather than long-term predictions because its forecasts can either converge to a stable value (e.g., they settle on one value over time) or diverge uncontrollably over time e.g., they grow to be very large as we go further into the future). The reliability of the ARIMA 247 forecasts hinges on the assumption that the residuals are uncorrelated and normally distributed; if this assumption is violated, the prediction intervals may become unreliable. Also, ARIMA 247 forecasts are prone to trend errors when there is a change in trend near the end of the training period and if seasonality is not accounted for. The model's architecture is defined by three parameters: (i) the order of the autoregressive part (p), (ii) the degree of differencing to make a stationary time series (d), and (iii) the order of the moving average part (q). These parameters are crucial for specifying the structure and behavior of the ARIMA 247 model, and determining its suitability for capturing the underlying patterns in the time series data.

FIG. 2G is a diagram that illustrates the train model stage 245 of the pipeline for capturing and forecasting time series data, according to aspects of the disclosure. Specifically, ARIMA 247 may incorporate AR (p) model 253, which uses a specified number of lagged observations as input to predict future values. These autoregressive models are adept at modeling the momentum and persistence of time series data. Additionally, ARIMA 247 may include MA (q) model 255, which may utilize past forecast errors in a moving average process to refine predictions. By integrating these components, ARIMA 247 may balance the influence of past values (AR) with the impact of past prediction errors (MA), thereby enhancing the accuracy and robustness of short-term forecasts. This dual approach may allow the pipeline to leverage the strengths of both autoregressive and moving average techniques in capturing the underlying patterns and dependencies in the data.

FIG. 2H is a diagram that illustrates the train model stage 245 of the pipeline where LSTM network 249 is utilized, according to aspects of the disclosure. Neural network models, such as LSTM network 249, have proven to be effective in outperforming ARIMA models in numerous scenarios. LSTMs generally perform well when there is a large amount of data, though effective and efficient hyperparameter tuning may be difficult to perform. LSTM network 249 is a specialized type of recurrent neural network (RNN) widely used in time series forecasting. LSTM network 249 is particularly effective due to its ability to maintain long-term dependencies in data through its unique architecture involving gates. These gates control the flow of information, allowing the LSTM network 249 to keep, forget, or ignore data points based on a probabilistic model. For example, the hidden state hₜ, cell state A, and input Xₜ may progress through sequence 257: h₀, A, X₀; h₁, A, X₁; h₂, A, X₂. A sequence of past values of variables, such as daily gas prices and inventory levels over the past week (denoted as hₜ, A, Xₜ) may be inputted into the LSTM network 249 to predict future sales. Using a series of gates, each with its own RNN, LSTM network 249 may probabilistically decide to keep, forget, or ignore data points, thereby refining their predictions. After each prediction the output is fed back into the model to predict the next value in the sequence, enabling the LSTM network 249 to learn from past predictions and iteratively improve its forecasting accuracy.

FIG. 2I illustrates a train model phase of the pipeline that utilizes a diverse array of models to ensure robust and accurate forecasting, according to aspects of the disclosure. In one instance, the current model list 259 may include SARIMAX, Facebook Prophet, PyTorch LSTMs, Quantile Regression, and Tree-based models. Each of these models may offer unique strengths in handling different aspects of time series data and forecasting challenges.

In one example, the SARIMAX model may be a generalization of ARIMA models that take into account seasonality and exogenous variables. In addition to the parameters (p, d, q), it has seasonal versions of P, D, Q, and a season length parameter m. The SARIMAX model may be useful in predicting on short forecast horizon, and may be better than ARIMA models at capturing effects due to seasonality, but may still be prone to errors due to outliers near the end of the training periods.

In one example, the Facebook Prophet model may approach time series modeling as a curve-fitting problem. This model may take the form of an additive model, where it is a sum of functions that capture different phenomena in a time series. Facebook Prophet may have multiple advantages over ARIMA, such as (i) it may accommodate seasonality with multiple periods, (ii) it may accommodate new additive modeling components, (iii) it does not require that data points are regularly spaced and interpolating missing values is not required when outliers are removed, (iv) it may be fit quickly using back fitting or Stan's L-BFGS, and (v) it may have interpretable parameters capturing things like a trend, seasonality, holidays/special events.

In one example, Quantile Regression model may be close to probabilistic forecasts, which provide forecast estimates in the form of a probability distribution. For example, the 2^{nd}, 10^{th}, 25^{th}, 75^{th}, 90^{th}, and 98^{th} quantiles are estimated for each time point t in the forecast horizon. The interpretation of the forecasts is different than the forecasts of an ARIMA model where the forecasts are read as falling within some range of values with a certain probability.

In supervised learning frameworks, the tree-based model is a common complement to parametric-based models. The appeal to using the tree-based model is the flexibility offered by this model in handling non-linear data. The tree-based model may fit lines to data using non-parametric methods, which may give this model much more flexibility than their linear and parametric counterparts. In one instance, the adaptive forecasting system 101 may incorporate five types of tree-based modeling algorithms: Random Forests, Gradient Boosting, Histogram Gradient Boosting, Extra Trees, and Adaboost. Each of these time series modeling algorithms may approach the problem in a distinct, unique way. The performance of these models may decide which method to choose. In one instance, the adaptive forecasting system 101 may add new time series modeling techniques whenever they are developed.

In one instance, the adaptive forecasting system 101 may perform hyperparameter tuning 261 using a package called Hyperopt. Hyperparameter tuning is a critical aspect of optimizing model performance, and the system 101 may employ Bayesian optimization for this purpose. Hyperopt is an open-source Bayesian optimizer, and tries to minimize the loss as a function of all the model hyperparameters in a Bayesian way (i.e., it is not merely randomly searching a grid of parameter values, it is intelligently learning which combinations of values work well as it goes, and focusing the search there, essentially performing a smart grid search). In one example, as models are built, Hyperopt learns about their losses and determines which combinations of hyperparameters seem to be promising and which seem to not be working out. It explores in depth only the promising combinations, which saves a lot of time. Hyperopt may also be integrated with Spark, so modeling jobs can be run in parallel on Spark clusters instead of on just one machine. In finding the best model, the adaptive forecasting system 101 may track the results from the Hyperopt experiments. This process is automated and parallelized using Hyperopt, enabling efficient and thorough exploration of the hyperparameter space to identify the best configuration for each model.

FIG. 2J is a diagram that illustrates the productionize stage of the machine-learning-enhanced forecasting pipeline, according to aspects of the disclosure. In the productionize phase 263, MLflow may be leveraged to manage and streamline the entire lifecycle of the machine-learning models. MLflow may track model training processes and hyperparameter tuning, ensuring all experiments and their results are meticulously documented. Once the optimal models are identified, they are registered to a central location within MLFlow, making them easily accessible and manageable. This registration process enables seamless deployment of the models for consumption in a production environment. The workflow 265 may encompass train, track, register, productionize, and forecast stages, ensuring that models are not only developed and optimized but also deployed efficiently to provide on-demand forecasts.

In one example, the train stage of the workflow 265 may initialize an experiment for each group and model type, and train all the prediction models with the training set. In one example, the track models stage of the workflow 265 may conduct a hyperparameter tuning within each experiment and may log each run. The track models may stop running when the loss metric has reached a minimum. In one example, the register stage of the workflow 265 may sort through all model runs, rank the model with the best out of the sample performance, and register the best model to the ML Flow Model repository. In one example, the productionize stage of the workflow 265 may deploy the most recently registered model to production and move all previous models to the archive. In one example, the forecast stage of the workflow 265 may pull models registered to production and may use them to generate forecasts. In one instance, the MLflow may tackle four primary functions:
1. Tracking experiments to record and compare parameters and results;
2. Packaging ML code in a reusable, reproducible form in order to share with other data scientists or transfer to production;
3. Managing and deploying models from a variety of ML libraries to a variety of model serving and inference platforms; and
4. Providing a central model store to collaboratively manage the full lifecycle of an MLflow Model, including model versioning, stage transitions, and annotations.

FIGS. 2K-2R are diagrams that illustrate the predict stage of the machine-learning-enhanced forecasting pipeline, according to aspects of the disclosure. In FIG. 2K, a recursive forecasting step is employed during the predict stage 267 to generate forecasts for the outcome variable (e.g., sales). This approach may involve using the model's predictions as inputs for subsequent predictions, enabling the generation of a forecast sequence. The output is organized into a comprehensive table 269 that may include various relevant variables and their lags. In this example, the table 269 includes the date, sales, sales lag 1, sales lag 2, sales lag 3, inventory (inv), inventory lag 1, gas price (Gas), and gas prices lag 1. By incorporating these lagged variables, the adaptive forecasting system 101 may capture temporal dependencies and interaction between different factors, improving the accuracy and robustness of the forecasts. The structured table 269 may facilitate a clear and detailed view of the predicted outcomes and their influencing factors over the forecast horizon.

In FIG. 2L, the production model may be loaded from MLflow. Once the model is loaded, it may utilize the input data to generate forecasts. This process may employ recursive forecasting, where the model's output for one time step becomes an input for the next, thereby creating a sequence of forecasts. Specifically, the model may predict values for the sales column 271 in the table 269. By filling in the sales column with the forecasted values, the adaptive forecasting system 101 may provide a comprehensive set of predictions that may account for past data trends and interactions among different variables. The adaptive forecasting system 101, via visualization module 117, may generate a presentation of table 269, graph 283, or any other graphical illustrations in a user device 104 associated with a user. In one example, the user device 104 may include, but is not restricted to, any type of mobile terminal, wireless terminal, fixed terminal, or portable terminal. Examples of the user device 104 may include, but are not restricted to, a mobile handset, a wireless communication device, a unit, a device, a multimedia computer, a multimedia tablet, an Internet node, a communicator, a desktop computer, a laptop computer, a notebook computer, a netbook computer, a tablet computer, a Personal Communication System (PCS) device, a Personal Digital Assistant (PDA), an infotainment system, a dashboard computer, a television device, or any combination thereof, including the accessories and peripherals of these devices, or any combination thereof. In addition, the user device 104 may facilitate various input means for receiving and generating information, including, but not restricted to, a touch screen capability, a keyboard, and keypad data entry, a voice-based input mechanism, and the like. Any known and future implementations of the user device 104 are also applicable.

In FIG. 2M, once the sales predictions are populated in the table 269, the next phase involves observing the values in the filled-in columns for sales, sales lags, inventory, inventory lags, gas prices, and gas price lags. With the newly predicted sales values, it is crucial to calculate and populate the lagged variables to maintain the integrity of the time series analysis. Specifically, the adaptive forecasting system 101 may calculate sales lag 1, sales lag 2, and sales lag 3, which may represent the sales figures from one, two, and three time periods prior, respectively. Additionally, the adaptive forecasting system 101 may calculate invoice lag 1 and gas lag 1, which are the inventory and gas prices from the previous time period. These lagged values are then populated in their respective columns (e.g., 273) of the table 269, ensuring that the dataset remains comprehensive and ready for subsequent forecasting cycles.

In FIG. 2N, the adaptive forecasting system 101 may utilize univariate forecasts from earlier stages to generate predictions for the exogenous features, such as inventory (Inv) and gas prices (Gas). These univariate models, which have been trained on their respective historical data, are employed to forecast future values for these features independently. Once these forecasts are generated, the predicted values for inventory and gas prices are populated into the empty tabs of the tables under their respective columns (e.g., 275 and 277). By filling in these exogenous features columns, the dataset is being prepared for the recursive forecasting process ensuring that relevant variables are accounted for and that the model can leverage comprehensive data to produce accurate forecasts.

In FIG. 2O, the adaptive forecasting system 101 may fill the remaining empty tabs of inventory lag 1 and gas lag 1 in the dataset. These lagged variables may be crucial for capturing the temporal dependencies and interaction within the data, ensuring that the prediction model can accurately predict future outcomes.

In FIG. 2P, the prepared group of inputs, including lagged sales, inventory, and gas price values, along with the newly forecasted exogenous features, are utilized as input into the prediction model. With this comprehensive set of features, the model may effectively estimate forecasts for the target variable Y, which typically represent sales. In this example, from table 269, one specific row 279 may be selected to serve as the basis for generating Y forecasts. This row may encompass the relevant historical data and lagged variables required for the model to make accurate predictions for the target time period.

In FIGS. 2Q and 2R, once the forecasted value for the target variable Y is generated for the selected time point, the next step is to populate the lagged variable for this forecasted value. These lagged variables, including sales lag 1, sales lag 2, and sales lag 3, are calculated based on the forecasted value of Y and its historical values. By incorporating these lagged variables, the dataset maintains the temporal dependencies necessary for accurate forecasting. Subsequently, these lagged variables are used as input to the model to generate forecasts for the next time point. Once these forecasts are obtained, they are filled into the remaining tabs in the table 269 for sales, sales lag 1, sales lag 2, and sales lag 3. This is an iterative process that is repeated until the table is filled with forecasted values and their lags. The forecasted data is written to the data lake as a spark table. In this instance, table 269 of FIG. 2R is the final output.

FIG. 2S is a diagram that illustrates the predict stage of the machine-learning-enhanced forecasting pipeline, according to aspects of the disclosure. The adaptive forecasting system 101, via visualization module 117, may generate a comparative graph 283 in a user interface of a user device 104 for evaluating the performance of the prediction model. In one example, the comparative graph 283 may include line 284 which represents the forecasted value generated by the prediction model, while line 285 depicts the actual value observed in real-world data. Additionally, line 286 represents the forecasts generated by the legacy forecasting system, allowing for a direct comparison between the new and the old forecasting methodologies. By comparing these lines the accuracy and reliability of the forecasting system may be assessed, with any discrepancies between forecasted and actual values providing valuable feedback for further refinement and improvement of the forecasting process.

In one example, the comparative graph 283 not only visualizes the forecasted and actual values but also includes the average percentage difference from the actual values for the last three periods for over 300 products. As the scale of the operation expands and more data, including external factors, are incorporated into the system, improvements accumulate rapidly. While line 284 closely tracks line 285, indicating a strong alignment between forecasted and actual value, it does not match perfectly, which may be a positive sign as perfect alignment may suggest overfilling. Notably, line 284 exhibits closer proximity to line 285 compared to line 286, further underscoring the effectiveness of the new forecasting approach in capturing and predicting trends more accurately.

In one instance, the adaptive forecasting system 101, via visualization module 117, may generate a presentation of a graph 287 in a user interface of the user device 104 associated with a user (as illustrated in FIG. 2T). The graph 287 may compare the prediction model's forecast 288 with the True RSV (Revenue Sales Volume) 289. In this example, the y-axis of the graph 287 may represent RSV which ranges from $0 to $14,000,000, and x-axis of the graph 287 may represent a specified timeline (e.g., from November 2021 to December 2024), providing a clear chronological context for the data points. This visual representation may allow for a detailed analysis of the model's forecasting accuracy over time. By juxtaposing the prediction model's forecast 288 with the actual RSV 289, the graph 287 may highlight periods of accuracy as well as areas where the model's predictions diverge from the true values. This comparative analysis facilitates the evaluation of the model's performance and identifies trends, patterns, and anomalies in the sales data over the specified period.

In one instance, the adaptive forecasting system 101, via visualization module 117, may generate a presentation of a graph 290 in a user interface of the user device 104 associated with a user (as illustrated in FIGS. 2U-2W). In this example, the y-axis of the graph 290 may represent the actual sales volume in metric tons (MT), and may quantify the amount of product sold from 0 to 2000 metric tons, and the x-axis of the graph 290 may represent a specified timeline that tracks the sales volume over different time interval. The graph 290 includes bars 293 indicating the actual MT values, and also compares the prediction model's forecast 291 against the status quo 292, allowing for an assessment of the model's performance against existing forecasting methods. By juxtaposing the prediction model's forecast 291 with the status quo 292, the graph 290 may provide insight into how closely the model's forecasts align with the current methods, highlighting areas where it performs better or diverges from current forecasting methods. Such comparative analysis may facilitate validation of the model's accuracy and reliability.

As illustrated in FIGS. 2U-2W, the prediction model's forecast 291 touches the bars 293 indicating that the model's predictions are closely aligned with the actual data points. This may suggest that the model is accurately capturing and reflecting patterns and trends in the actual data providing reliable forecasts. In one instance, the prediction model's forecast 291 touching the bars 293 may also signify a correlation between the model's predictions and the actual values, which may enhance the confidence of the model's predictive capability.

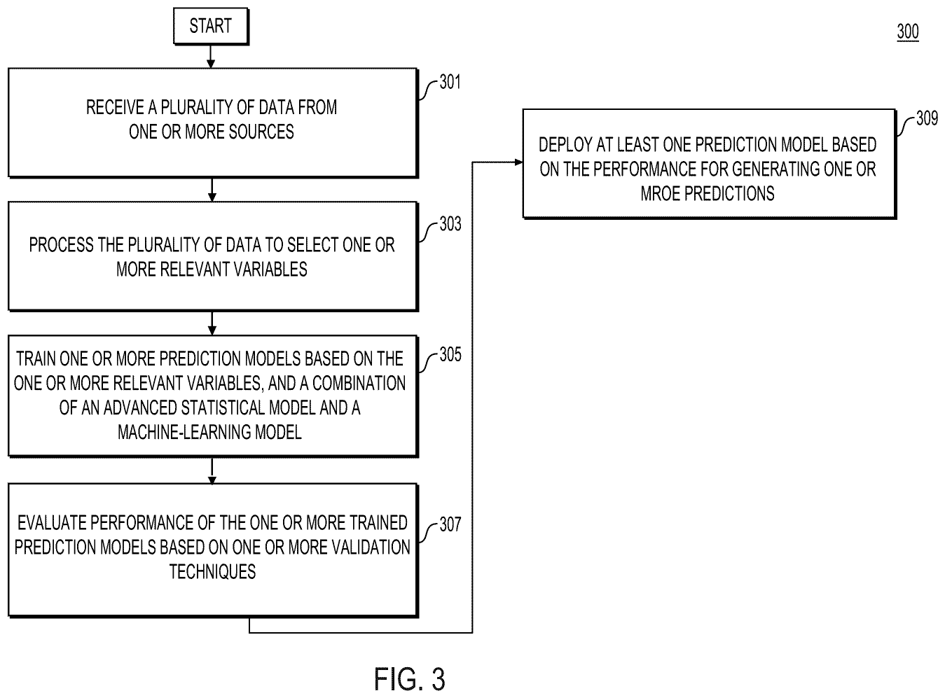

FIG. 3 is a flowchart of a process for adaptive forecasting using advanced statistical models and machine-learning models, according to aspects of the disclosure. In various embodiments, the adaptive forecasting system 101 and/or any of the modules 105-119 may perform one or more portions of the process 300 and are implemented using, for instance, a chip set including a processor and a memory as shown in FIG. 5. As such, the adaptive forecasting system 101 and/or any of modules 105-119 may provide means for accomplishing various parts of the process 300, as well as means for accomplishing embodiments of other processes described herein in conjunction with other components of the system 100. Although the process 300 is illustrated and described as a sequence of steps, it is contemplated that various embodiments of the process 300 may be performed in any order or combination and need not include all of the illustrated steps.

In step 301, the adaptive forecasting system 101 may receive a plurality of data from one or more sources (e.g., data source 103). In one instance, the plurality of data may include historical data (e.g., historical sales data), market data, economic indicators, weather data, or any other relevant data.

In step 303, the adaptive forecasting system 101 may process the plurality of data to select relevant variables. In one instance, the adaptive forecasting system 101 may detect and impute missing values in the plurality of data using imputation techniques. This may include identifying gaps or anomalies in the dataset where values are missing. Once detected, the adaptive forecasting system 101 may employ various imputation techniques (e.g., mean, median, or mode imputation, forward or backward filling, and advanced algorithms like K-Nearest neighbors) to fill these gaps. In one instance, the adaptive forecasting system 101 may perform smoothing and transforming of the relevant variables. Smoothing may include techniques such as moving averages or exponential smoothing to reduce noise and fluctuations in the data, thereby revealing underlying patterns and trends. Transforming the relevant variables may include applying mathematical operations like scaling, logarithmic transformations, and differencing. These transformations may be crucial for normalizing the data, handling outliers, and making the time series stationary, which may enhance the prediction model's ability to learn from data efficiently. In one instance, the adaptive forecasting system 101 may normalize features in the plurality of data using normalization techniques. Common normalization techniques may include min-max scaling, which may adjust the values based on the minimum and maximum values of each feature, and z-score normalization, which may standardize the data based on its mean and standard deviation. The adaptive forecasting system 101 may ensure data integrity and consistency by harmonizing different formats and structures to create a unified dataset for subsequent processing and analysis.

In one instance, relevant variables may include an exogenous feature including economic indicators, weather data, promotional events, or any time-based data provided by the user. In one instance, the adaptive forecasting system 101 may utilize feature selection techniques to select relevant variables that significantly contribute to the prediction model's performance. This process may include statistical tests, correlation analysis, or machine learning algorithms, to evaluate the importance of each variable. By analyzing the relationship between variables and target outcomes, the adaptive forecasting system 101 may prioritize variables that may provide the most predictive power. In one instance, the adaptive forecasting system 101 may utilize advanced techniques such as correlation analysis or principal component analysis (PCA) to assess the significance and relevance of each variable. In one instance, the adaptive forecasting system 101 may perform simulations to assess the significance of one or more variables in the plurality of data. For example, feature importance simulations, including perturbation methods and statistical tests, may be conducted to determine the impact of individual variables on model performance. The adaptive forecasting system 101 may analyze results from the simulations to identify variables with high effects on model predictions.

In step 305, the adaptive forecasting system 101 may train the prediction models based on relevant variables and a combination of an advanced statistical model and a machine-learning model. In one example, the advanced statistical model may include ARIMA, SARIMAX, or Exponential Smoothing. It should be understood that the advanced statistical model may include any known or future implementation of the time-series model. In one example, the machine-learning model may include LSTM, Random Forests, deep learning models, Gradient Boosting Machines, Transformers, ExtraTrees, AdaBoost, XGBoost, or LightGBM. It should be understood that the machine-learning model may include any known or future implementation of the time-series model.

In one instance, the adaptive forecasting system 101 may identify the relevant variables within the plurality of data based on correlation analysis that may quantify the strength and direction of relationships between two continuous variables. In one instance, the adaptive forecasting system 101 may identify the relevant variables within the plurality of data based on statistical analysis. In one example, the statistical analysis may include regression analysis which may model the relationship between dependent and independent variables. In one example, the statistical analysis may include hypothesis testing which may evaluate the statistical significance of observed relationships. These relevant variables may have a strong linear relationship with a target variable and may contribute to explaining variance in the target variable more than randomly generated data that may lack any inherent relationships with the target variable. The adaptive forecasting system 101 may input the relevant variables into the advanced statistical model and the machine-learning model to analyze patterns between the relevant variables and the target variable. In one example, the pattern may include temporal patterns that may examine how variables behave over different periods for identifying trends, cycles, or seasonal variations in the target variable. The advanced statistical model may capture time-series patterns and trends, while the machine-learning model may learn complex relationships and non-linearities within the data. Integrating both statistical and machine-learning models may enhance the accuracy and robustness of the forecasts, adapting effectively to various data patterns and external influences.

In one instance, the adaptive forecasting system 101 may identify an optimal hyperparameter of the machine-learning model using a Bayesian optimization. In one instance, Bayesian optimization may use a probabilistic model to predict the performance of different hyperparameter configurations and iteratively selects the most promising configurations to evaluate. By focusing on the most informative areas of the hyperparameters space, this method may reduce the number of evaluations needed compared to traditional techniques. This process may ensure that the machine-learning models are fine-tined for maximum accuracy and performance adapting to the specific characteristics of the data.

Additionally or alternatively, the adaptive forecasting system 101 may determine a combination of parameters for the advanced statistical model using a grid search technique to identify the optimal configuration that minimizes prediction error. Grid search may systematically evaluate each possible combination of parameter values, such as the order of autoregressive terms (p), the degree of differencing (d), and the order of the moving average (q) for ARIMA models. By training and validating the model with each parameter set on a validation dataset, grid search may identify combinations that may achieve the best performance.

The adaptive forecasting system 101 may apply cross-validation to assess the performance of the hyperparameter configurations of the advanced statistical model (e.g., parameters) and machine-learning model and prevent overfitting. In one example, the model may be trained on some subsets while validated on the remaining ones, ensuring that each subset is used for validation at least once. This approach may provide for a comprehensive evaluation of the model's performance across different data splits, providing insights into its generalization capability.

In one instance, the adaptive forecasting system 101 may utilize parallel processing techniques during the processing of the plurality of data and training of the prediction models. This approach may leverage a distributed computing framework, for example, distributing data preprocessing tasks, such as handling missing values and feature engineering, across multiple processors, to reduce the time required for data preparation. Additionally, parallel execution of hyperparameter tuning and model training across various statistical and machine-learning models may accelerate the optimization process. The adaptive forecasting system 101 may integrate hyperparameter tuning into the machine-learning model and parameter optimization into the advanced statistical model.

In step 307, the adaptive forecasting system 101 may evaluate the performance of the trained prediction models based on validation techniques. In one instance, the adaptive forecasting system 101 may rigorously assess the accuracy, reliability, and robustness of the prediction model post-training. This evaluation may utilize various validation techniques, such as cross-validation or time-series validation, to ensure that the model's predictive capability is consistent and effective across different datasets or time points. By employing these validation techniques, the system ensures that the trained prediction model meets predefined standards before it is deployed for on-demand forecasting.

In step 309, the adaptive forecasting system 101 may deploy at least one prediction model based on the performance for generating one or more predictions. In one example, the adaptive forecasting system 101 may generate on-demand predictions upon receiving a specific request, allowing users to obtain forecasts based on the latest available data at any given moment. This capability is particularly useful for scenarios requiring immediate insights, such as sudden market shifts or urgent inventory management decisions. In another example, the adaptive forecasting system 101 may generate real-time predictions, such predictions may be continuously updated as new data streams in, enabling the system to provide ongoing, dynamic forecasts. Such real-time capability is crucial for applications that require constant monitoring and quick adaptation to changing conditions, such as real-time sales tracking or live supply chain management. In one instance, the adaptive forecasting system 101 may monitor the performance of at least one deployed model using performance metrics. In one example, the adaptive forecasting system 101 may continuously monitor the performance of the deployed prediction model by collecting and analyzing various performance metrics. These performance metrics may include mean absolute error (MAE), root mean squared error (RMSE), mean absolute percentage error (MAPE), or other relevant statistical measure that measures the accuracy and reliability of the model's predictions. By tracking these metrics, the adaptive forecasting system 101 may detect deviations or anomalies in the model's performance, allowing for timely adjustments, re-training, or refinement of the models to adapt to changing patterns and ensure forecasting accuracy.

In one example, the adaptive forecasting system 101 may train a plurality of prediction models (e.g., over 300,000 predictive models) within a predetermined time period (e.g., approximately 24 hours) to forecast sales demand for a predetermined number of products-retailer pairs (e.g., 5,000 products-retailer pairs). The adaptive forecasting system 101, utilizing advanced algorithms, may identify the optimal model for each individual product-retailer pair by evaluating and comparing the performance of different prediction models. Once the best model is determined, their final predictions are seamlessly integrated into the business systems, ensuring that the forecasts are readily available for decision-making processes. This high-throughput and automated approach enables precise and timely demand forecasting, enhancing inventory management and operational efficiency for the retailer.

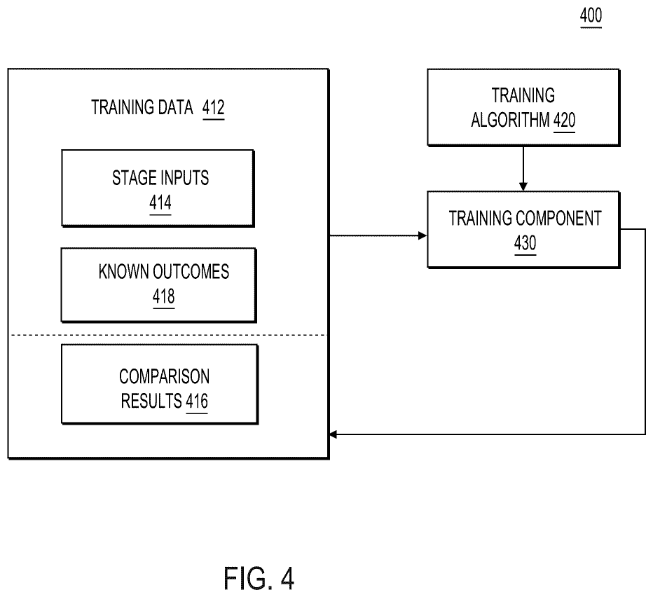

One or more implementations disclosed herein include and/or may be implemented using a machine-learning model. For example, one or more of the modules of the adaptive forecasting system 101 may be implemented using a machine-learning model and/or may be used to train the machine-learning model. A given machine-learning model may be trained using the training flow chart 400 of FIG. 4. Training data 412 may include one or more of stage inputs 414 and known outcomes 418 related to the machine-learning model to be trained. The stage inputs 414 may be from any applicable source including text, visual representations, data, values, comparisons, stage outputs, e.g., one or more outputs from one or more actions or operations from FIG. 3. The known outcomes 418 may be included for the machine-learning models generated based upon supervised or semi-supervised training. An unsupervised machine-learning model may not be trained using known outcomes 418. Known outcomes 418 may include known or desired outputs for future inputs similar to, or in the same category as, stage inputs 414 that do not have corresponding known outputs.

The training data 412 and a training algorithm 420, e.g., one or more of the modules implemented using the machine-learning model and/or may be used to train the machine-learning model, may be provided to a training component 430 that may apply the training data 412 to the training algorithm 420 to generate the machine-learning model. According to an implementation, the training component 430 may be provided comparison results 416 that compare a previous output of the corresponding machine-learning model to apply the previous result to re-train the machine-learning model. The comparison results 416 may be used by training component 430 to update the corresponding machine-learning model. The training algorithm 420 may utilize machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, models specifically discussed in the present disclosure, or the like.

The machine-learning model used herein may be trained and/or used by adjusting one or more weights and/or one or more layers of the machine-learning model. For example, during training, a given weight may be adjusted (e.g., increased, decreased, removed) based upon training data or input data. Similarly, a layer may be updated, added, or removed based upon training data/and or input data. The resulting outputs may be adjusted based upon the adjusted weights and/or layers.

In general, any process or operation discussed in this disclosure is understood to be computer-implementable, such as the processes illustrated in FIG. 3 may be performed by one or more processors of a computer system as described herein. A process or process step performed by one or more processors may also be referred to as an operation. The one or more processors may be configured to perform such processes by having access to instructions (e.g., software or computer-readable code) that, when executed by one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

FIG. 5 illustrates an implementation of a computer system that may execute techniques presented herein. The computer system 500 can include a set of instructions that can be executed to cause the computer system 500 to perform any one or more of the methods or computer based functions disclosed herein. The computer system 500 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, “analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

In a networked deployment, the computer system 500 may operate in the capacity of a server or as a client user computer in a server-client user network environment, or as a peer computer system in a peer-to-peer (or distributed) network environment. The computer system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 500 can be implemented using electronic devices that provide voice, video, or data communication. Further, while the computer system 500 is illustrated as a single system, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics processing unit (GPU), or both. The processor 502 may be a component in a variety of systems. For example, the processor 502 may be part of a standard personal computer or a workstation. The processor 502 may be one or more processors, digital signal processors, application specific integrated circuits, field programmable gate arrays, servers, networks, digital circuits, analog circuits, combinations thereof, or other now known or later developed devices for analyzing and processing data. The processor 502 may implement a software program, such as code generated manually (i.e., programmed).

The computer system 500 may include a memory 504 that can communicate via bus 508. The memory 504 may be a main memory, a static memory, or a dynamic memory. The memory 504 may include but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 504 includes a cache or random-access memory for the processor 502. In alternative implementations, the memory 504 is separate from the processor 502, such as a cache memory of a processor, the system memory, or other memory. The memory 504 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 504 is operable to store instructions executable by the processor 502. The functions, acts or tasks illustrated in the figures or described herein may be performed by the processor 502 executing the instructions stored in the memory 504. The functions, acts, or tasks are independent of the particular type of instruction set, storage media, processor or processing strategy and may be performed by software, hardware, integrated circuits, firmware, micro-code and the like, operating alone or in combination. Likewise, processing strategies may include multiprocessing, multitasking, parallel processing, and the like.

As shown, the computer system 500 may further include a display 510, such as a liquid crystal display (LCD), an organic light emitting diode (OLED), a flat panel display, a solid-state display, a cathode ray tube (CRT), a projector, a printer or other now known or later developed display device for outputting determined information. The display 510 may act as an interface for the user to see the functioning of the processor 502, or specifically as an interface with the software stored in the memory 504 or in the drive unit 506.

Additionally or alternatively, the computer system 500 may include an input/output device 512 configured to allow a user to interact with any of the components of the computer system 500. The input/output device 512 may be a number pad, a keyboard, or a cursor control device, such as a mouse, or a joystick, touch screen display, remote control, or any other device operative to interact with the computer system 500.

The computer system 500 may also or alternatively include drive unit 506 implemented as a disk or optical drive. The drive unit 506 may include a computer-readable medium 522 in which one or more sets of instructions 524, e.g. software, can be embedded. Further, instructions 524 may embody one or more of the methods or logic as described herein. The instructions 524 may reside completely or partially within the memory 504 and/or within the processor 502 during execution by the computer system 500. The memory 504 and the processor 502 also may include computer-readable media as discussed above.

In some systems, computer-readable medium 522 includes the set of instructions 524 or receives and executes the set of instructions 524 responsive to a propagated signal so that a device connected to network 530 can communicate voice, video, audio, images, or any other data over the network 530. Further, the set of instructions 524 may be transmitted or received over the network 530 via communication port or interface 520, and/or using bus 508. The communication port or interface 520 may be a part of the processor 502 or may be a separate component. The communication port or interface 520 may be created in software or may be a physical connection in hardware. The communication port or interface 520 may be configured to connect with a network 530, external media, the display 510, or any other components in computer system 500, or combinations thereof. The connection with the network 530 may be a physical connection, such as a wired Ethernet connection or may be established wirelessly as discussed below. Likewise, the additional connections with other components of the computer system 500 may be physical connections or may be established wirelessly. The network 530 may alternatively be directly connected to the bus 508.

While the computer-readable medium 522 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that causes a computer system to perform any one or more of the methods or operations disclosed herein. The computer-readable medium 522 may be non-transitory, and may be tangible.

The computer-readable medium 522 can include a solid-state memory such as a memory card or other package that houses one or more non-volatile read-only memories. The computer-readable medium 522 can be a random-access memory or other volatile re-writable memory. Additionally or alternatively, the computer-readable medium 522 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Computer system 500 may be connected to network 530. The network 530 may define one or more networks including wired or wireless networks. The wireless network may be a cellular telephone network, an 802.10, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 530 may include wide area networks (WAN), such as the Internet, local area networks (LAN), campus area networks, metropolitan area networks, a direct connection such as through a Universal Serial Bus (USB) port, or any other networks that may allow for data communication. The network 530 may be configured to couple one computing device to another computing device to enable communication of data between the devices. The network 530 may generally be enabled to employ any form of machine-readable media for communicating information from one device to another. The network 530 may include communication methods by which information may travel between computing devices. The network 530 may be divided into sub-networks. The sub-networks may allow access to all of the other components connected thereto or the sub-networks may restrict access between the components. The network 530 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an example, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

It should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of the present disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method comprising:
receiving, by one or more processors, a plurality of data from one or more sources;
processing, by the one or more processors, the plurality of data to select one or more relevant variables;
training, by the one or more processors, one or more prediction models based on the one or more relevant variables, and a combination of an advanced statistical model and a machine-learning model;
evaluating, by the one or more processors, performance of the one or more trained prediction models based on one or more validation techniques; and
deploying, by the one or more processors, at least one prediction model based on the performance for generating one or more predictions.

2. The computer-implemented method of claim 1, wherein processing the plurality of data to select the one or more relevant variables comprises:
causing, by the one or more processors, a detection and an imputation of missing values in the plurality of data using one or more imputation techniques;
normalizing, by the one or more processors, one or more features in the plurality of data using one or more normalization techniques; and
selecting, by the one or more processors, the one or more relevant variables using one or more feature selection techniques.

3. The computer-implemented method of claim 2, wherein training the one or more prediction models comprises:
identifying, by the one or more processors, the one or more relevant variables within the plurality of data based on one or more of correlation analysis or statistical analysis, wherein the one or more relevant variables has strong linear relationship with a target variable; and
inputting, by the one or more processors, the one or more relevant variables into the advanced statistical model and the machine-learning model, wherein the advanced statistical model and the machine-learning model analyze patterns between the one or more relevant variables and the target variable.

4. The computer-implemented method of claim 3, further comprising:
identifying, by the one or more processors, an optimal hyperparameter of the machine-learning model using a Bayesian optimization;
applying, by the one or more processors, cross-validation to assess performance of one or more hyperparameter configurations and prevent overfitting; and
integrating, by the one or more processors, hyperparameter tuning into the machine-learning model and parameter optimization into the advanced statistical model.

5. The computer-implemented method of claim 3, wherein the advanced statistical model includes Autoregressive Integrated Moving Average (ARIMA), Seasonal Autoregressive Integrated Moving Average With Exogenous Variables (SARIMAX), or Exponential Smoothing.

6. The computer-implemented method of claim 3, wherein the machine-learning model includes Long Short Term Memory (LSTM), Random Forests, deep learning models, Gradient Boosting Machines, Transformers, ExtraTrees, AdaBoost, XGBoost, or LightGBM.

7. The computer-implemented method of claim 1, further comprising:
monitoring, by the one or more processors, the performance of the at least one deployed model using performance metrics; and
re-training, by the one or more processors, the deployed models based on updated data to adapt to changing patterns and trends.

8. The computer-implemented method of claim 1, wherein the one or more relevant variables include an exogenous feature, and wherein the exogenous feature comprises economic indicators, weather data, or promotional events.

9. The computer-implemented method of claim 1, further comprises:
performing, by the one or more processors, one or more simulations to assess significance of one or more variables in the plurality of data; and
analyzing, by the one or more processors, one or more results from the one or more simulations to identify variables with high effects on model predictions.

10. The computer-implemented method of claim 1, wherein processing the plurality of data and training the one or more prediction models utilize parallel processing techniques.

11. A system comprising:
one or more processors of a computing system; and
at least one non-transitory computer readable medium storing instructions which, when executed by the one or more processors, cause the one or more processors to perform operations comprising:
receiving a plurality of data from one or more sources;
processing the plurality of data to select one or more relevant variables;
training one or more prediction models based on the one or more relevant variables, and a combination of an advanced statistical model and a machine-learning model;
evaluating performance of the one or more trained prediction models based on one or more validation techniques; and
deploying at least one prediction model based on the performance for generating one or more predictions.

12. The system of claim 11, wherein processing the plurality of data to select the one or more relevant variables comprises:
causing a detection and an imputation of missing values in the plurality of data using one or more imputation techniques;
normalizing one or more features in the plurality of data using one or more normalization techniques; and
selecting the one or more relevant variables using one or more feature selection techniques.

13. The system of claim 12, wherein training the one or more prediction models comprises:
identifying the one or more relevant variables within the plurality of data based on one or more of correlation analysis or statistical analysis, wherein the one or more relevant variables has strong linear relationship with a target variable; and
inputting the one or more relevant variables into the advanced statistical model and the machine-learning model, wherein the advanced statistical model and the machine-learning model analyze patterns between the one or more relevant variables and the target variable.

14. The system of claim 13, further comprising:
identifying an optimal hyperparameter of the machine-learning model using a Bayesian optimization;
applying cross-validation to assess performance of one or more hyperparameter configurations and prevent overfitting; and
integrating hyperparameter tuning into the machine-learning model and parameter optimization into the advanced statistical model.

15. The system of claim 13, wherein the advanced statistical model includes Autoregressive Integrated Moving Average (ARIMA), Seasonal Autoregressive Integrated Moving Average With Exogenous Variables (SARIMAX), or Exponential Smoothing.

16. The system of claim 13, wherein the machine-learning model includes Long Short Term Memory (LSTM), Random Forests, Gradient Boosting Machines, Transformers, ExtraTrees, AdaBoost, XGBoost, or LightGBM.

17. The system of claim 11, further comprising:
monitoring the performance of the at least one deployed model using performance metrics; and
re-training the deployed models based on updated data to adapt to changing patterns and trends.

18. A non-transitory computer readable medium, the non-transitory computer readable medium storing instructions which, when executed by one or more processors of a computing system, cause the one or more processors to perform operations comprising:
receiving a plurality of data from one or more sources;
processing the plurality of data to select one or more relevant variables;
training one or more prediction models based on the one or more relevant variables, and a combination of an advanced statistical model and a machine-learning model;
evaluating performance of the one or more trained prediction models based on one or more validation techniques; and
deploying at least one prediction model based on the performance for generating one or more predictions.

19. The non-transitory computer readable medium of claim 18, wherein processing the plurality of data to select the one or more relevant variables comprises:
causing a detection and an imputation of missing values in the plurality of data using one or more imputation techniques;
normalizing one or more features in the plurality of data using one or more normalization techniques; and
selecting the one or more relevant variables using one or more feature selection techniques.

20. The non-transitory computer readable medium of claim 18, wherein training the one or more prediction models comprises:
identifying the one or more relevant variables within the plurality of data based on one or more of correlation analysis or statistical analysis, wherein the one or more relevant variables has strong linear relationship with a target variable; and
inputting the one or more relevant variables into the advanced statistical model and the machine-learning model, wherein the advanced statistical model and the machine-learning model analyze patterns between the one or more relevant variables and the target variable.
